(19) United States
(12) Patent Application Publication
(10) Pub. No.: US 2007/0011331 A1
(43) Pub. Date: Jan. 11, 2007

(54) Autonomous control apparatus, autonomous control method, and autonomous control program

(75) Inventors: Kenji Morimoto, Kawasaki (JP); Motomitsu Adachi, Tokyo (JP); Youji Kohda, Yokohama (JP); Satoshi Tsuchiya, Kawasaki (JP); Akira Katsuno, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/366,751

(22) Filed: Mar. 3, 2006

(30) Foreign Application Priority Data
Jul. 11, 2005 (JP) 2005-202007
Aug. 3, 2005 (JP) 2005-225093

(51) Int. Cl. G06F 15/173

(52) U.S. Cl. 709/226; 709/223

(57) ABSTRACT

An autonomous control apparatus includes a service-structure analyzing unit for generating service policy information indicating a configuration requirement, in response to business policy information indicating a business requirement; a policy compiler for generating a control policy, which serves an actual IT-resource control requirement, from the service policy information generated by the service-structure analyzing unit, based on previous-case information stored in an operation database; and a flow controller for controlling IT resources in accordance with the control policy generated by the policy compiler.

### BACKGROUND OF THE INVENTION

1. Field of the Invention

The present invention relates to an autonomous control apparatus, an autonomous control method, and an autonomous control program which autonomously control an information processing system constituted by a plurality of information processing apparatuses and connected thereto through a network. In particular, the present invention relates to an autonomous control apparatus, an autonomous control method, and an autonomous control program which can perform flexible autonomous control in accordance with a control (requirement) policy of an information processing system.

2. Description of the Related Art

Today, in web systems and so on, a large amount of processing is performed as needed and cannot thus be handled by a single IT resource.

Accordingly, a coordinated system using multiple IT resources is configured. A typical example of such a system is a three-layer system that uses a web server serving as a gateway for a client, an application IT resource for performing various processing based on a request issued from the client and received by the web server, and a database IT resource for performing database search according to a request for the application IT resource. In addition, configuring an IT resource system in which each IT resource is constituted by multiple IT resources makes it possible to perform a large amount of processing. However, the system is complicated, thus making it difficult for the resources to operate in an optimum state and in a coordinated manner.

For example, a load fluctuation due to time, a day of the week, month, and so on may occur depending on a service, so that configuring an optimum system at one point does not necessarily lead to an improvement in the efficiency of the entire operation.

Also, when a failure occurs, switching to a degeneration operation and/or an alternative IT resource needs to be promptly and appropriately performed. The complexity of the current system, however, makes it difficult to promptly identify a malfunctioning portion causing the failure and to take measures therefor.

Additionally, it is desired that future forecast be performed and an operation considering the future state be performed.

For the processing described above, the administrator of the system needs to monitor the state of the system and to adjust the system configuration to the monitored state. Consequently, the efficiency of the operation depends on the know-how of the system administrator and, as the system becomes more complicated, it is more difficult for the administrator to perform an efficient operation.

In addition to control for stabling the operation, the cost of the system increases as the scale of the system becomes larger and more work for management is required as the system becomes larger and more complicated. Thus, there is a need to flexibly make a change to the system, while considering the balance between an effect resulting from additional installment of hardware/software and cost for the installment.

For example, an IT resource may be additionally installed to ensure responses, but improper addition of an IT resource merely leads to an increase in operation cost and does not provide an optimum operation rate of each IT resource.

In recent years, in order to address the problems described above, as described in Non-patent Document (“Bijinesu-wo-Sasaeru TRIOLE (TRIOLE SUPPORTING BUSINESS)”, Magazine Fujitsu, issued on Jan. 11, 2005, Vol. 56, No. 1 (series No. 326), P9 to P15), autonomous operation control in which a system performs various controls based on hierarchical policies without requiring the involvement of the administrator is under study.

In the policy control, more abstract concepts are specified as the policy hierarchy rises, and more concrete policies are defined as the hierarchy decreases. In a lowest-order execution policy, commands for each piece of hardware and software are specified.

A certain number of reserve IT resources are required to achieve flexible policy operation and it is also desired that flexible operation be performed so that the IT resources respond quickly to processing required for the system.

For such policy control, Patent Document 1 (Japanese Unexamined Patent Application Publication No. 2004-162442 (not published at the time of application)) filed by the present assignee discloses a scheme for controlling reserve IT resources.

Non-patent Document 1 noted above describes the hierarchical concepts of a business policy indicating a business requirement, a service policy indicating a quantitative system performance operation rule, a control policy indicating a logic action, and an execution policy serving as an actual execution command and also describes the necessity of conversion from a high-order policy into a low-order policy.

Also patent Document 1 specifically describes the conversion from the control policy into the execution policy.

However, in the known technologies described above, there is no disclosure about specific control for converting the business policy into the service policy and converting the service policy into the control policy.

### SUMMARY OF THE INVENTION

Accordingly, the present invention discloses control for converting a business policy into a service policy and converting a service policy into a control policy and an object of the present invention is to provide an autonomous control apparatus, an autonomous control method, and an autonomous control program which are capable of performing control for converting a business policy into an execution policy.

To achieve the foregoing object, the present invention provides an autonomous control program. The program causes a computer to function as: a service-structure analyzing unit for generating service policy information indicating a configuration requirement, in response to business policy information indicating a business requirement; a policy compiler for generating a control policy from the service policy information generated by the service-structure analyzing unit, based on a previous case or a result of verification using simulation, the control policy serving an actual IT-resource control requirement; and a flow controller for controlling IT resources in accordance with the control policy generated by the policy compiler.

Preferably, the service policy information generated by the service-structure analyzing unit includes an item for a step of reducing the number of IT resources.

Preferably, the item for reducing the number of IT resources is capable of specifying a control instruction for changing the number of operation IT resources to one.

Preferably, the item for reducing the number of IT resources is capable of specifying a control instruction for reducing the number of operation IT resources.

Preferably, the service policy information generated by the service-structure analyzing unit includes items for specifying average response time and peak response time; and the policy compiler generates control policy information, while referring to whether or not values are specified for the average response time and the peak response time in the service policy information generated by the service-structure analyzing unit.

The flow controller may include functional modules having respective functions; a controller for calling up each functional module by using a common interface defined for each functional module; and an adapter for converting a format of the call-up into a format that can be understood by a functional module to be called up and for supplying resulting information to the functional module to be called up.

Preferably, the flow controller is capable of performing a plurality of flow controls based on the control policy and includes a high-order flow controller for performing IT-resource adjustment between the flow controls.

Then present invention further provides an autonomous control program. The program causes a computer to execute: a service-structure analyzing step of generating service policy information indicating a configuration requirement, in response to business policy information indicating a business requirement; a policy generating step of generating a control policy from the service policy information generated in the service-structure analyzing step, based on a previous case or a result of verification using simulation, the control policy serving as an actual IT-resource control requirement; and a flow controlling step of controlling IT resources in accordance with the control policy generated in the policy generating step.

The service policy information generated by the service-structure analyzing unit includes an item for a step of reducing the number of IT resources.

Preferably, the service policy information generated by the service-structure analyzing unit includes items for specifying average response time and peak response time; and the policy compiler generates control policy information, while referring to whether or not values are specified for the average response time and the peak response time in the service policy information generated by the service-structure analyzing unit.

The flow controlling step may include a module controlling step of calling up each functional module by using a common interface defined for each functional module; and a step of converting a format of the call-up into a format that can be understood by a functional module to be called up and of supplying resulting information to the functional module to be called up.

Preferably, in the flow controlling step, a plurality of flow controls can be performed based on the control policy and IT-resource adjustment between the flow controls is performed.

The present invention further provides an autonomous control apparatus. The apparatus includes: a service-structure analyzing unit for generating service policy information indicating a configuration requirement, in response to business policy information indicating a business requirement; a policy compiler for generating a control policy from the service policy information generated by the service-structure analyzing unit, based on a previous case or a result of verification using simulation, the control policy serving an actual IT-resource control requirement; and a flow controller for controlling IT resources in accordance with the control policy generated by the policy compiler.

Preferably, the service policy information generated by the service-structure analyzing unit includes an item for a step of reducing the number of IT resources.

Preferably, the service policy information generated by the service-structure analyzing unit includes items for specifying average response time and peak response time; and the policy compiler generates control policy information, while referring to whether or not values are specified for the average response time and the peak response time in the service policy information generated by the service-structure analyzing unit.

The flow controller may include: functional modules having respective functions; a controller for calling up each functional module by using a common interface defined for each functional module; and an adapter for converting a format of the call-up into a format that can be understood by a functional module to be called up and for supplying resulting information to the functional module to be called up.

Preferably, the flow controller is capable of performing a plurality of flow controls based on the control policy and includes a high-order flow controller for performing IT-resource adjustment between the flow controls.

This arrangement allows business policy information to be converted into control policy information, while using previous cases or by using the result of simulation, and also can achieve autonomous control using control policy information by simply inputting business policy information.

### BRIEF DESCRIPTION OF THE DRAWINGS

FIG. 1 is a block diagram of an autonomous control system according to an embodiment of the present invention;

FIG. 2 is a block diagram of an example in which a management server is given the roll of IT resources in the autonomous control system of the embodiment of the present invention;

FIG. 3 is a block diagram of the management server in the autonomous control system of the embodiment of the present invention;

FIG. 4 is a flow chart showing processing performed by a service-structure analyzing unit;

FIG. 5 is a table showing relationships between business policies and service policies stored in a policy storage unit;

FIG. 6 is a table showing an example of service policy information;

FIG. 7 is a table showing number-of-IT-resource reduction basic policy information stored in a policy storage unit;

FIG. 8 is a table showing number-of-IT resource increase basic policy information stored in the policy storage unit;

FIG. 9 is a flow chart showing a processing procedure performed by a policy compiler;

FIG. 10 is a flow chart showing a processing procedure performed by the policy compiler;

FIG. 11 is a flow chart showing a processing procedure performed by the policy compiler;

FIG. 12 shows an example of a control policy;

FIG. 13 is a flow chart showing a processing procedure performed by the policy compiler;

FIG. 14 shows an example of the control policy;

FIG. 15 shows an example of the control policy;

FIG. 16 shows an example of the control policy;

FIG. 17 is a flow chart showing a processing procedure performed by the policy compiler;

FIG. 18 shows an example of the control policy;

FIG. 19 shows an example of the control policy;

FIG. 20 shows an example of the control policy;

FIG. 21 is a table showing an example of service policy information;

FIG. 22 shows an example of the control policy;

FIG. 23 includes graphs showing the response of the system and the number of operation IT resources versus time when autonomous control is performed based on the business policy in the embodiment of the present embodiment;

FIG. 24 includes graphs showing the response of the system and the number of operation IT resources versus time when autonomous control is performed based on the business policy in the embodiment of the present embodiment;

FIG. 25 is a block diagram of the management server in an autonomous control system according to another embodiment of the present invention;

FIG. 26 is a block diagram of the management server in an autonomous control system according to another embodiment of the present invention;

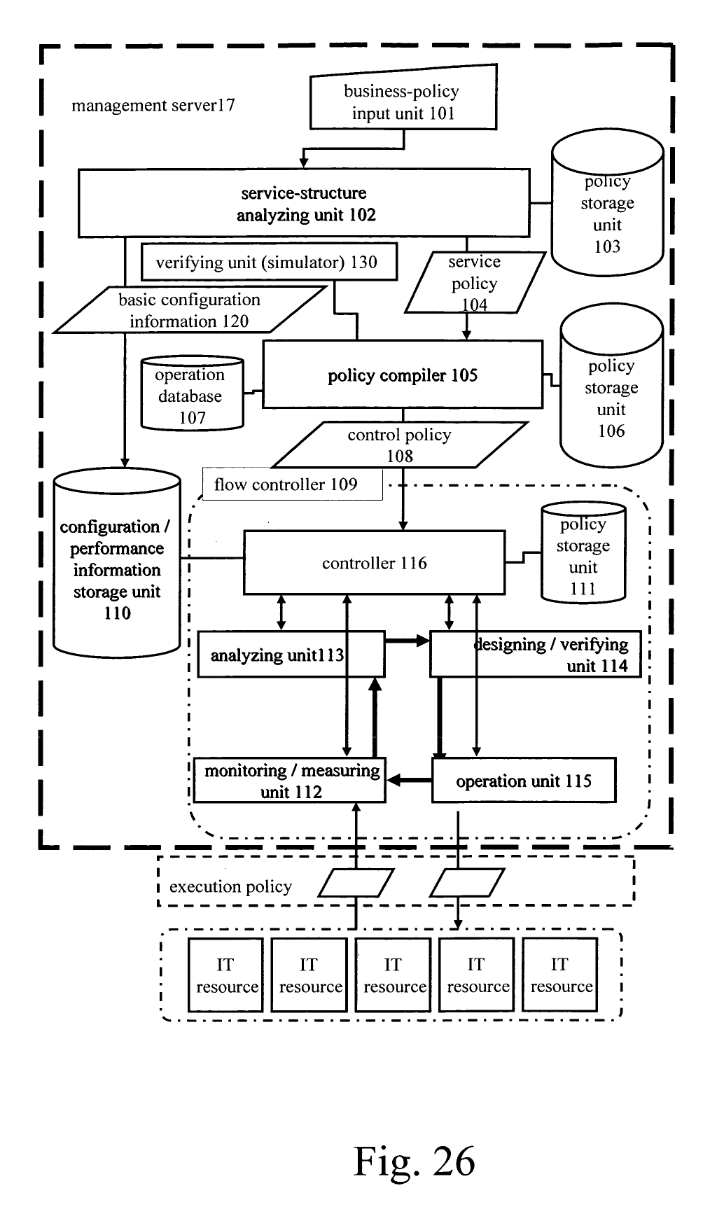

FIG. 27 is a block diagram showing an example of the configuration of a flow controller configured so that two or more policy operations in the present invention can be performed in the same system; and

FIG. 28 shows an example of the control policy.

### DESCRIPTION OF THE PREFERRED EMBODIMENTS

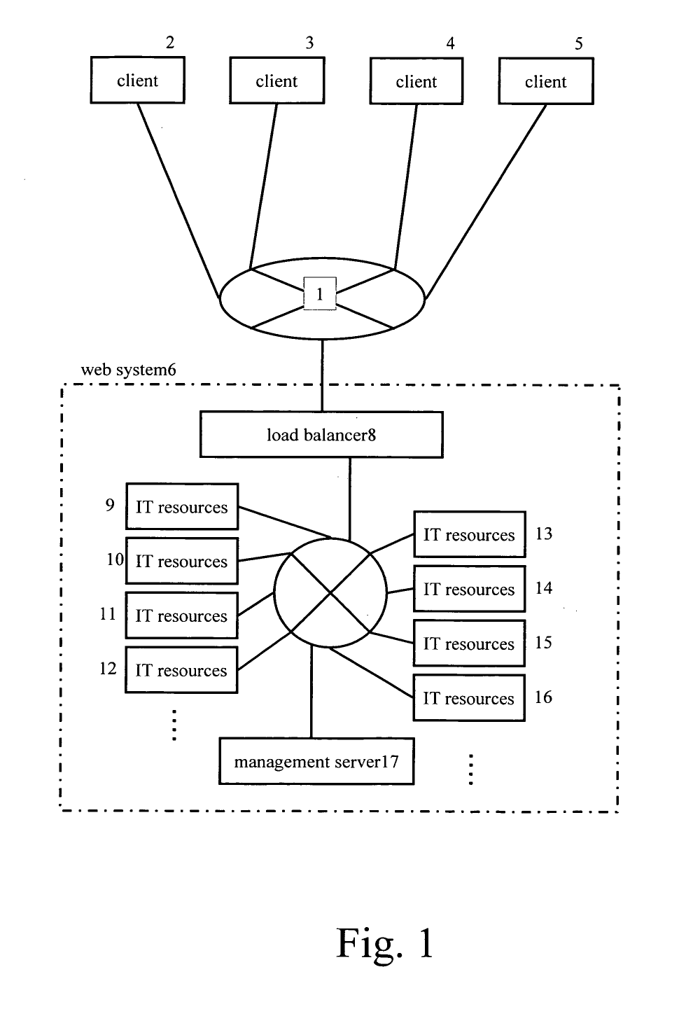

The configuration of an autonomous control system according to an embodiment of the present invention will first be described with reference to FIG. 1.

An autonomous control system of the present embodiment is applicable to a web system 6 connected to a wide-area network 1, such as the Internet, to which a plurality of clients (clients 2 to 5 in the present embodiment) are connected. The web system 6 processes a request issued from any of the clients 2 to 5 through the wide-area network 1 and transmits the processing result to the client that issued the request.

Individual elements of the web system 6 are connected to a dedicated high-speed network 7, which is different from the wide-area network 1, and transmit/receive information to/from other elements through the high-speed network 7.

The elements of the web system 6 will now be described.

First, a load balancer 8 is connected to the wide-area network 1 and performs processing for sending a request, received through the wide-area network 1, to another element in accordance with a predetermined definition.

General-purpose IT resources 9 to 16 can play various roles, based on installed software (OS and middle ware)

A management server 17 determines the roles of the IT resources 9 to 16 and manages the IT resources 9 to 16 so that they operate as a coordinated system.

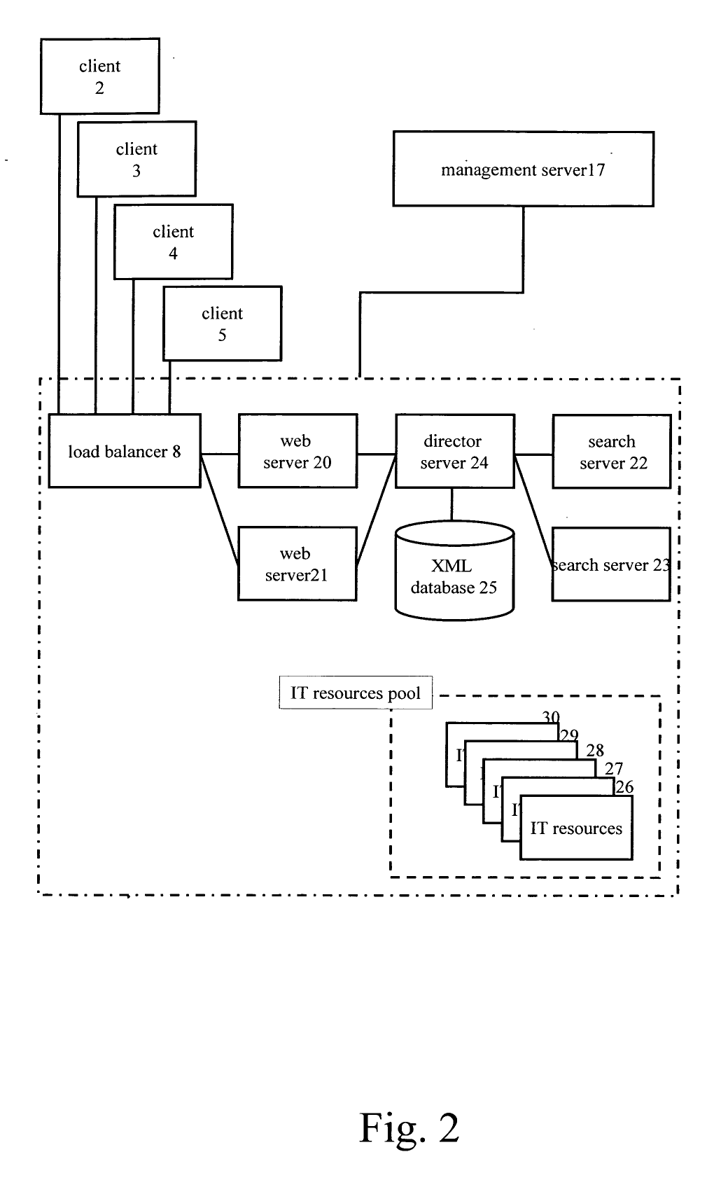

FIG. 2 shows an overview of IT resources whose roles have been determined by the management server 17.

With the configuration shown in FIG. 1, setting each IT resource allows a communication target to be appropriately determined. For example, depending on a setting, the load balancer 8 can send a request to only the IT resources 9 and 10. Thus, in the physical connection shown in FIG. 1, determining processing to be executed by each of the IT resources 9 to 16, installing an operating system (OS), middleware, application software in each IT resource to perform the determined processing, and appropriately restricting IT resources that can communicate allows the IT resources 9 to 16 to operate as a coordinated system.

An overview of the system is shown in FIG. 2.

In this example, the IT resources 9 to 16 have various software installed, so as to serve as web servers 20 and 21, a director server 24, and search servers 22 and 23. The web servers 20 and 21 analyze requests from the clients 2 to 5 and transmit the results to the search servers 22 and 23. Communication targets are appropriately pre-defined.

The management server 17 determines the configuration described above and issues instructions for software installment control and various settings so that each IT resource can perform specified processing.

In the configuration of the coordinated system, the load balancer 8 receives requests from the clients 2 to 5, appropriately distributes each request to either of the web servers 20 and 21. The web server 20 or 21 that has received the request converts the request into a database search language, such as SQL (structured query language), and sends the converted request to the director server 24. Further, the director server 24 sends the request to the search server 22 or 23 that actually performs search processing. The search server 22 or 23 that received the request performs processing for searching an XML database 25.

IT resource 26 to 30 included in a shared resource pool are redundant IT resources that are not currently given any roles. When the management server 6 changes the configurations of the IT resources 26 to 30, new roles can be given to the IT resources 26 to 30 to enhance the functions of the web servers and search severs.

Conversely, when the frequency of requests is low, for example, the web server function of one of two web servers 20 and 21 (the web server function of the web server 21 in the present embodiment) can be stopped and switched to the IT resource pool so that the IT resource pool is used for other insufficient resources.

The factor of the changing the configuration may be a business-related factor.

For example, in recent years, there is a service called the “on-demand service” in which a company that desires to use an IT resource rents a required amount of IT resource for a required amount of time.

The service is offered through processing in which the system configuration of a company having IT resources is changed to a system desired by another company that needs an IT resource. However, since this is a pay service, the fee is charged according to the amount of each IT resource. Thus, a company that receives the service does not want to keep more number of IT resources than required. Accordingly, specifications required by a company that receives the service need to be realized with an adequate number of IT resources.

Optimum IT resource management processing according to the need is performed by the management server 17.

That is, the management server 17 performs optimum IT resource management processing, based on a business requirement (a business policy) issued by the administrator.

The configuration of the management server 17 will be described next.

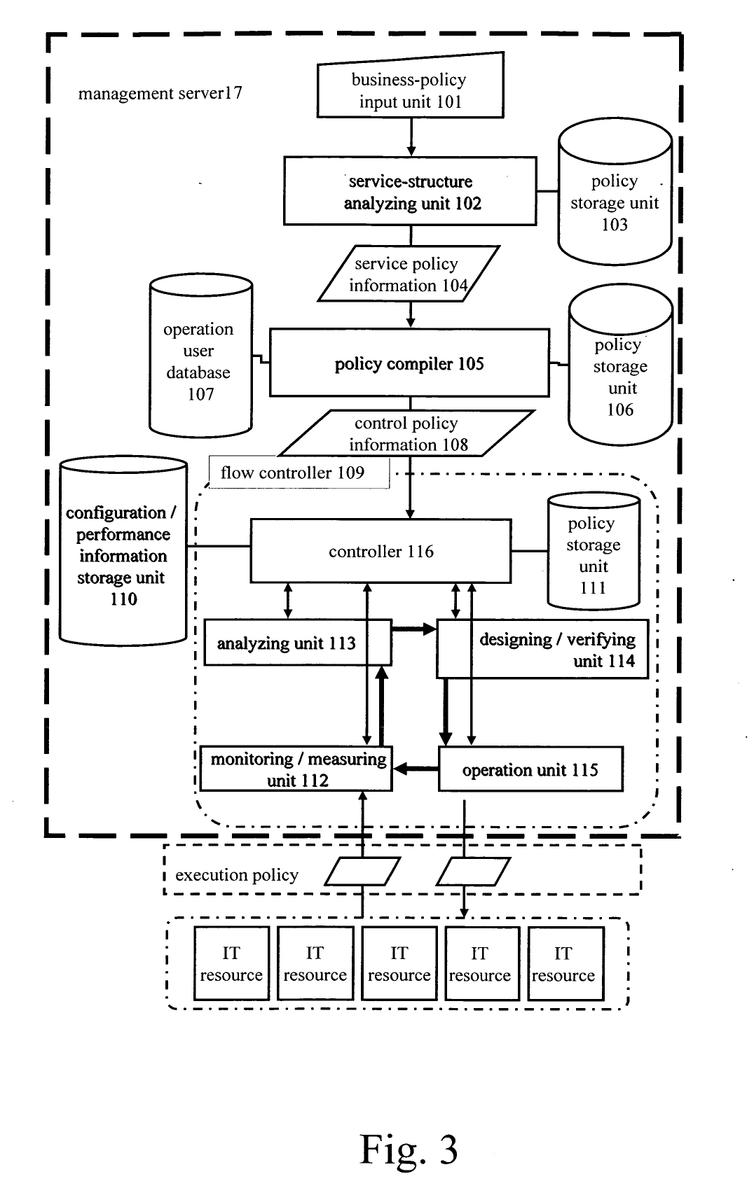

FIG. 3 is a block diagram of the management server 17.

A business-policy input unit 101 receives business policy information input by the system administrator.

For example, the business-policy input unit 101 receives an input from the user via a keyboard and/or a mouse, while displaying the input on a GUI (graphical user interface).

A service-structure analyzing unit 102 analyzes business policy information received from the business-policy input unit 101 and outputs the analyzed business policy information. The service-structure analyzing unit 102 can access a policy storage unit 103, which stores the business policy information received from the business-policy input unit 101 and various types of information (e.g., service policy information being generated) obtained as a result of service-policy information generation performed by the service-structure analyzing unit 102. Reference numeral 104 indicates service policy information analyzed by the service-structure analyzing unit 102.

A policy compiler 105 generates control policy information, based on the service policy information 104. The policy compiler 105 can access a policy storage unit 106, which stores the service policy information 104 output from the service-structure analyzing unit 102 and stores control policy information generated or being generated by the policy compiler 105.

In an operation user database 107, various types of history information of the previous operations are stored.

A flow controller 109 controls each IT resource in accordance with the control policy information 108 generated by the policy compiler 105.

The flow controller 109 can access a storage unit 110 that stores the current IT-resource configuration/performance information and can also access a policy storage unit 111 that stores the control policy information generated by the policy compiler 105.

The flow controller 109 includes a monitoring/measuring unit 112, an analyzing unit 113, a designing/verifying unit 114, an operation unit 115, and a controller 116. The monitoring/measuring unit 112 monitors/measures an IT resource of interest, in accordance with a condition defined by a control policy. The analyzing unit 113 performs analysis to determine whether or not information output from the monitoring/measuring unit 112 matches the control policy information. Based on the result of the analysis performed by the analyzing unit 113, the designing/verifying unit 114 designs/verifies the IT resource arrangement and so on, based on the control policy information. The operation unit 115 performs operations, such as issuing a control instruction to each IT resource, so as to satisfy IT resource distribution set by the designing/verifying unit 114. The controller 116 issues control instructions to the monitoring/measuring unit 112, the analyzing unit 113, the designing/verifying unit 114, and the operation unit 115 so as to perform control according to the control policy information generated by the policy compiler 105.

Now, the aforementioned various types of policy information will be described in more detail.

The business policy information input via the business-policy input unit 101 is policy information indicating a business plan, a profit condition, and so on.

The objective of the user is to efficiently make a profit within a limited budget and, when the objective is input, the system is adapted to autonomously configure the IT resources so as to achieve the objective.

The service policy information generated by the service-structure analyzing unit 102 indicates system performance requirement restrictions, such as “average system response time: 1300 ms or less” and “the number of usable IT resources: 10”, and other requirements (e.g., “average response time” in the example described above). The service-structure analyzing unit 102 analyzes business policy information input via the business-policy input unit 101 and generates service policy information.

The control policy information generated by the policy compiler 105 is policy information specifically indicating under what condition and how each IT resource is controlled to satisfy the actual performance/configuration restrictions of the system in accordance with the service policy information output from the service-structure analyzing unit 102. The policy compiler 105 generates the control policy information, based on the service policy information and previous operation case-information stored in the operation database 107.

IT-resource-control instruction information, such as an execution command, is sent from the operation unit 115 to each IT resource, and IT-resource state information is sent from each IT resource to the monitoring/measuring unit 112. Those pieces of information directly communicated between the flow controller 109 and each IT resource are used as execution policy information and, in practice, have a command format for communication.

Processing performed by the autonomous control system configured as described above will be described below.

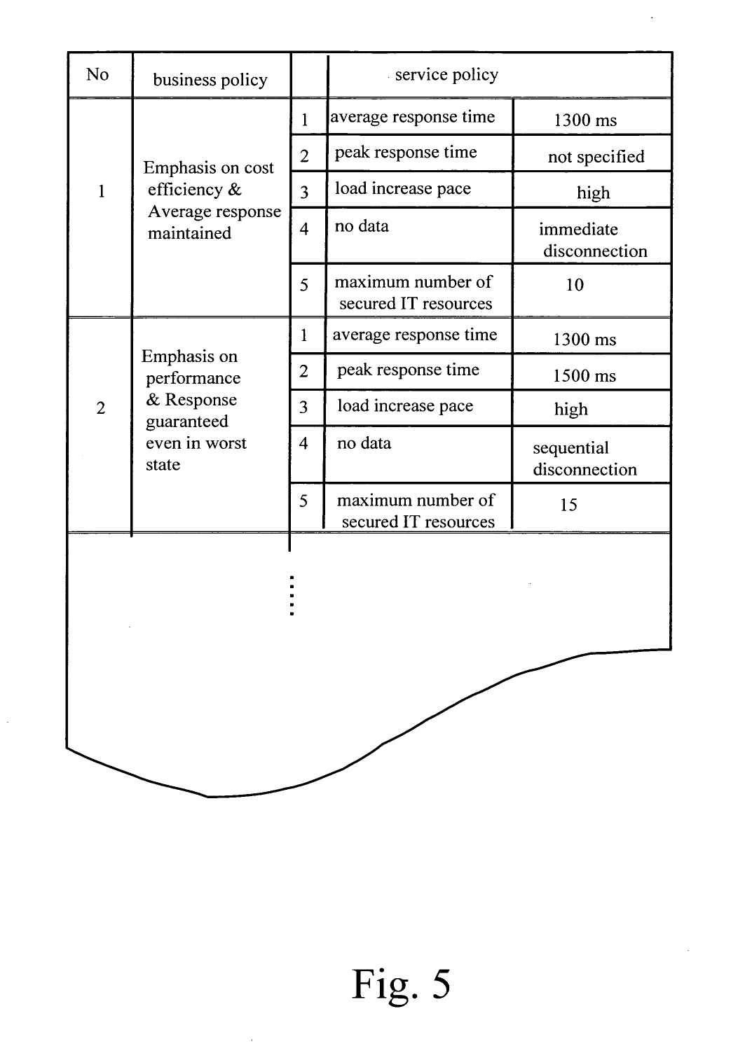

As shown in the table of FIG. 5, the policy storage unit 103 stores service policy information indicating system specification information and corresponding to “Emphasis on cost efficiency & Average response maintained” and “Emphasis on performance & Response guaranteed even in worst state”. In the present embodiment, service policy information for five items “average response time”, “peak response time”, “load increase pace”, “(processing in the case of) no data “, and “maximum number of secured IT resources” are associated and stored with respect to one business policy.

The definition of a service policy for each business policy will now be described.

Business policy information “Emphasis on cost efficiency & Average response maintained” defines that, even when the maximum response time (peak response) is somewhat sacrificed, the average response time is limited to a predetermined level and the number of IT resources during operation is reduced. That is, as shown in FIG. 5, although the item “average response time” is specified, the item “peak response time” is not particularly specified. The “no data” defines a case in which there is no data during processing and also indicates “immediate disconnection” indicating that one IT resource, which is the minimum number of resource, is left operated and all other IT resources are disconnected to put emphasis on cost efficiency. To put emphasis on cost efficiency, the number of IT resources for the item “maximum number of secured IT resources” is larger than for the case of “Emphasis on performance & Response guaranteed even in worst state” described below.

The business policy information “Emphasis on performance & Response guaranteed even in worst state” is intended to define that processing within a predetermined response time is guaranteed with respect to any request, in addition to maintaining the average response. Thus, values are specified for the item “average response time” and the item “peak response time”. Further, in order to handle a case in which a large number of requests exist after the processing of data is finished, “sequential disconnection” indicating that the number of operation IT resources is reduced one by one at regular intervals when data runs out during processing is specified for the item “no data”.

The present embodiment is based on the premise that it is known that the load increase pace is fast, and both of the items “load increase pace” in the service policy information are specified as “high”.

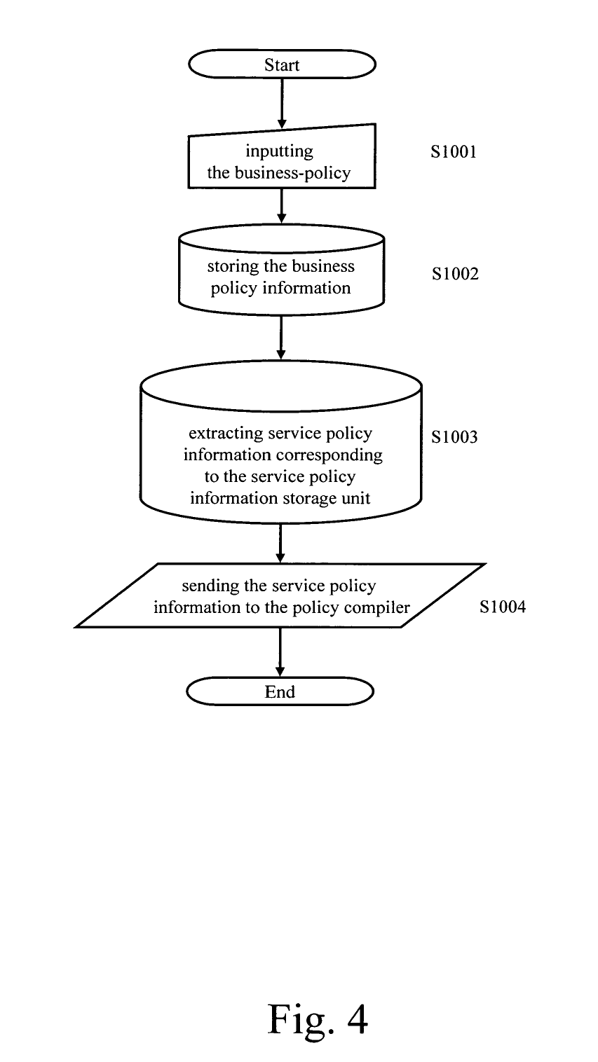

Based on the foregoing points, the processing of the service-structure analyzing unit 102 when business policy information is input to the business-policy input unit 101 will be described with reference to the flow chart shown in FIG. 4.

First, when business policy information is input to the business-policy input unit 101 in step S1001, the service-structure analyzing unit 102 stores the business policy information in the policy storage unit 103 in step S1002. In the case of the present embodiment, it is assumed that business policy information for “Emphasis on cost efficiency & Average response maintained” is input.

Next, in step S1003, the service-structure analyzing unit 102 refers to a service-policy-information—service-policy-information relationship table pre-stored in the policy-information storage unit 103, to extract service policy information corresponding to the business policy information stored in step S1002.

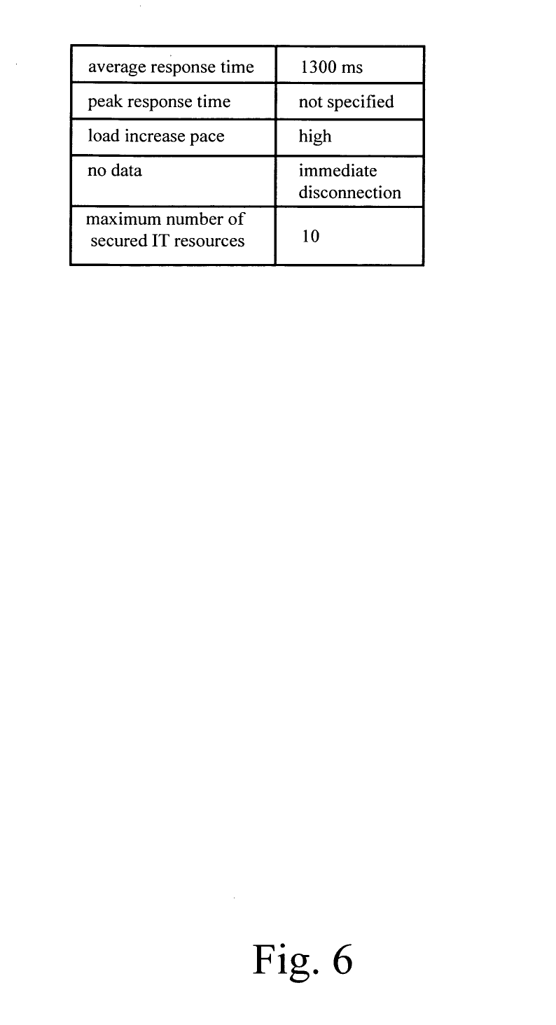

As described above, in the present embodiment, business policy information for the “Emphasis on cost efficiency & Average response maintained” is input, and the business-policy-information—service-policy-information relationship table as shown in the table in FIG. 5 is stored in the policy-information storage unit 103. Thus, as shown in FIG. 6, “average response time: 1300 ms”, “peak response time: not specified”, “load increase pace: high”, “no data: immediate disconnection”, and “maximum number of secured IT resources: 10” are extracted as the service policy information 104.

The service-structure analyzing unit 102 sends the extracted service policy information to the policy compiler 105.

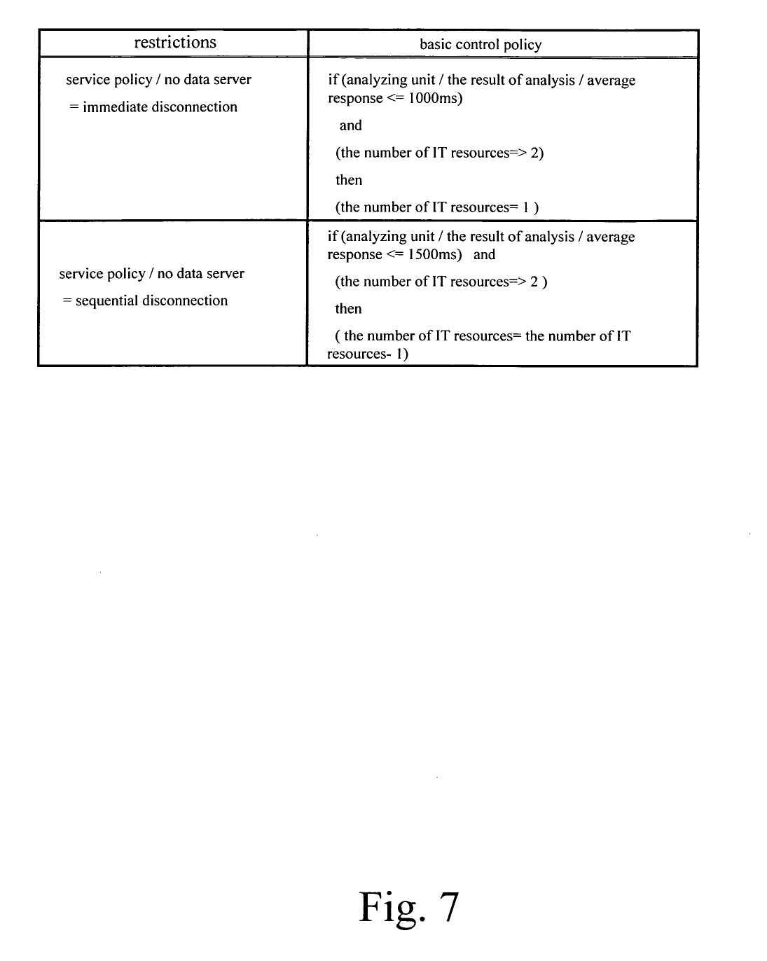

Next, control-policy generation processing performed by the policy compiler 105 in response to the service policy information will be described with reference to FIG. 7.

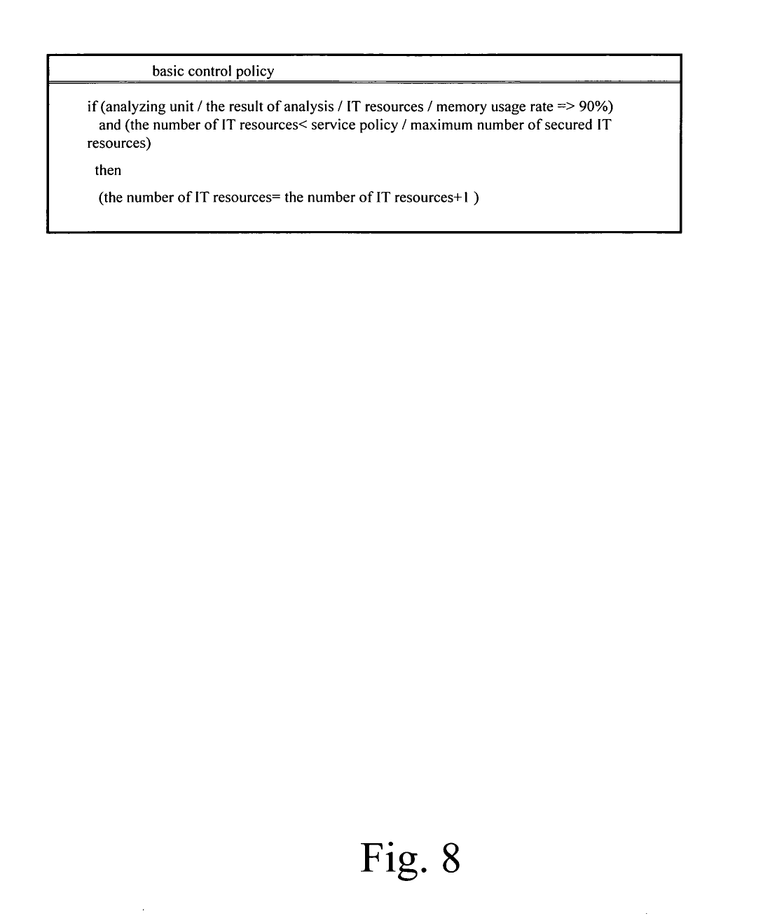

The policy storage unit 106, which can be accessed by the policy compiler 105 in the present embodiment, temporarily stores the service policy information 104 received from the service-structure analyzing unit 102 and a control policy generated during the control-policy generation processing performed by the policy compiler 105. Further, the policy storage unit 106 pre-stores basic policy information for reducing the number of IT resources, as shown in the table of FIG. 7, and basic policy information for increasing the number of IT resources, as shown in the table of FIG. 8.

The basic policy information for reducing the number of IT resources contains two pieces of basic control policy information in accordance with the value (immediate disconnection or sequential disconnection) of item “no data” of the service policy information.

First, in step S2001, the policy compiler 105 performs processing for receiving the service policy information from the service-structure analyzing unit 102.

If unable to receive the service policy information, in step S2002, the policy compiler 105 performs the processing in step S2001.

Upon determining that the service policy information is received in the processing in step S2002, the policy compiler 105 stores the service policy information in the policy storage unit 106 in step S2003.

Thereafter, in step S2004, the policy compiler 105 generates control policy information, based on the service policy information stored in the policy storage unit 106, the basic control policy information described above, and previous-case information stored in the operation database 107.

The control-policy-information generation processing in step S2004 will be described in detail.

The control policy generation processing in step S2004 in the present embodiment is performed in the order of monitor-interval setting processing (in step S3001), number-of-IT-resources reduction setting processing (in step S3002), and number-of-IT-resource increase setting processing (in step S3003).

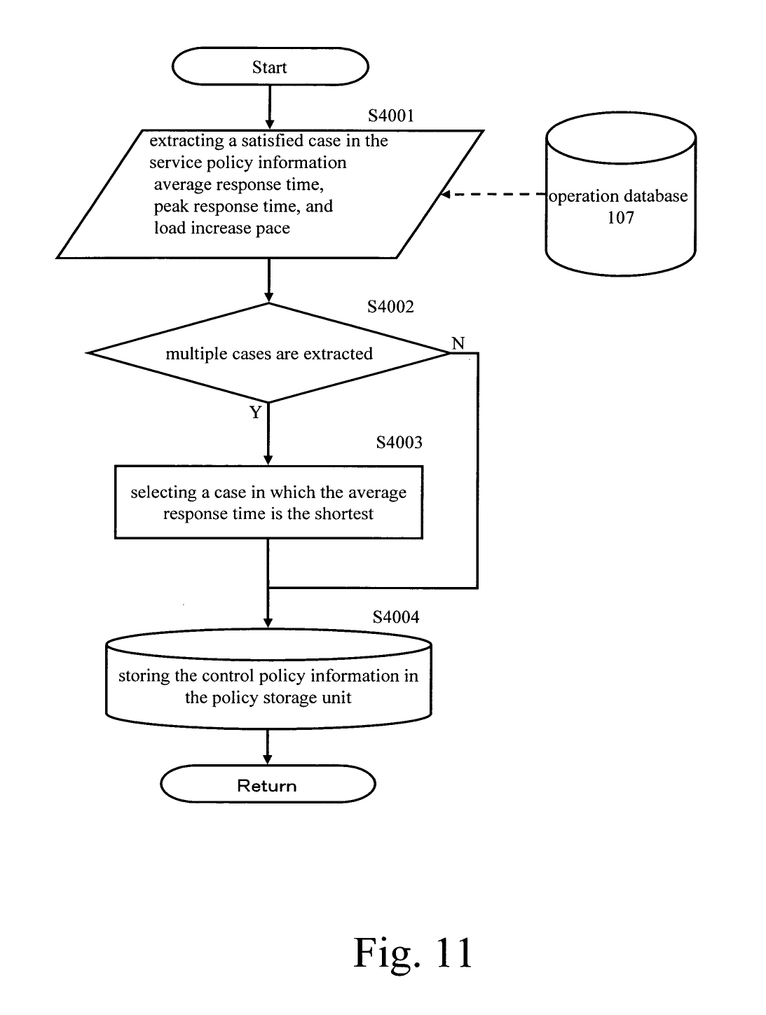

The monitor-interval setting processing (in step S3001) will first be described with reference to FIG. 11.

First, in step S4001, the policy compiler 105 refers to the operation database 107 to extract a previous case in which processing was performed with values less than the average response time” and the “peak response time” in the service policy information stored in the policy storage unit 106.

At this point, when multiple cases are extracted in step S4002, in step S4003, the policy compiler 105 selects a case in which the average response time is the shortest.

In step S4004, the policy compiler 105 then stores, as the control policy information, monitoring-time information used in the extracted and selected case.

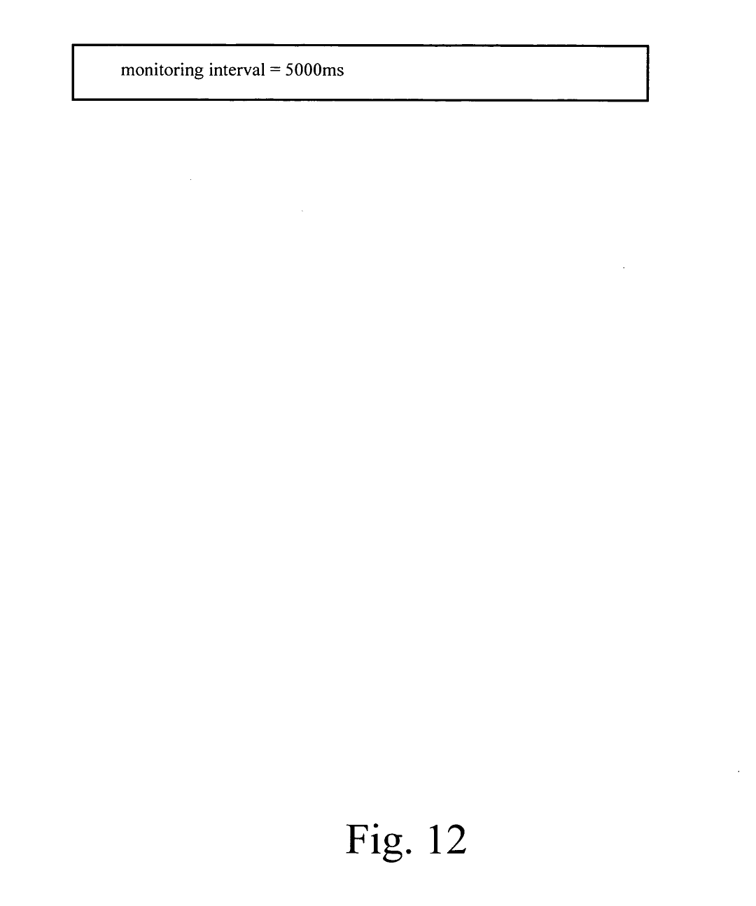

In the case of the present embodiment, since the monitoring interval of the previous case extracted and selected in the processing described above is 5000 ms, control policy information indicating a monitoring interval of 5000 ms, as shown in FIG. 12, is generated and is stored in the policy storage unit 106.

When this processing is completed, the policy compiler 105 performs number-of-IT-resource reduction setting processing (step S3002).

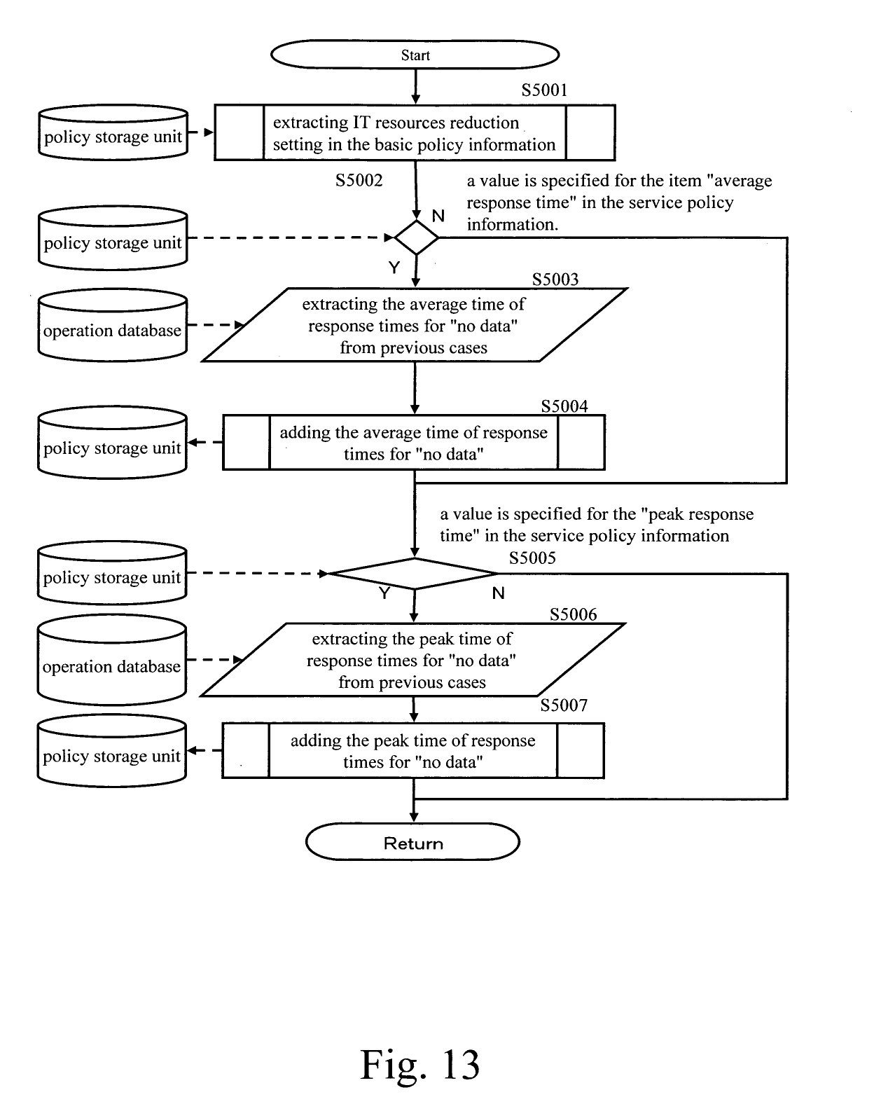

The number-of-IT-resource reduction setting processing (step S3002) will now be described with reference to FIG. 13.

First, of the number-of-IT-resource reduction basic policies shown in FIG. 7, the policy compiler 15 extracts, from the policy compiler 105, basic policy information corresponding to the conditions of the service policy information stored in the policy storage unit 106.

In the present embodiment, since a condition for selecting the number-of-IT-resource reduction basic policy information, which is shown in the number-of-IT reduction basic policy storage table in FIG. 7, indicates the item “no data” of the service policy, the policy compiler 105 refers to the item “no data” in the service policy information stored in the policy storage unit 106.

Thus, as described above, since the service policy information shown in FIG. 6 is stored in the policy storage unit 106 in the present embodiment, number-of-IT-resource reduction basic policy that matches the condition of “immediate disconnection” for the item “no data” in the service policy information stored in the policy storage unit 106 is selected and the selected number-of-IT-resource reduction basic policy information is additionally contained in the control policy information stored in step S4004. In this case, when a service policy information item is defined in the basic policy, the policy compiler 105 performs processing for changing the item portion to a value defined by the corresponding item of the service policy information stored in the policy storage unit 106.

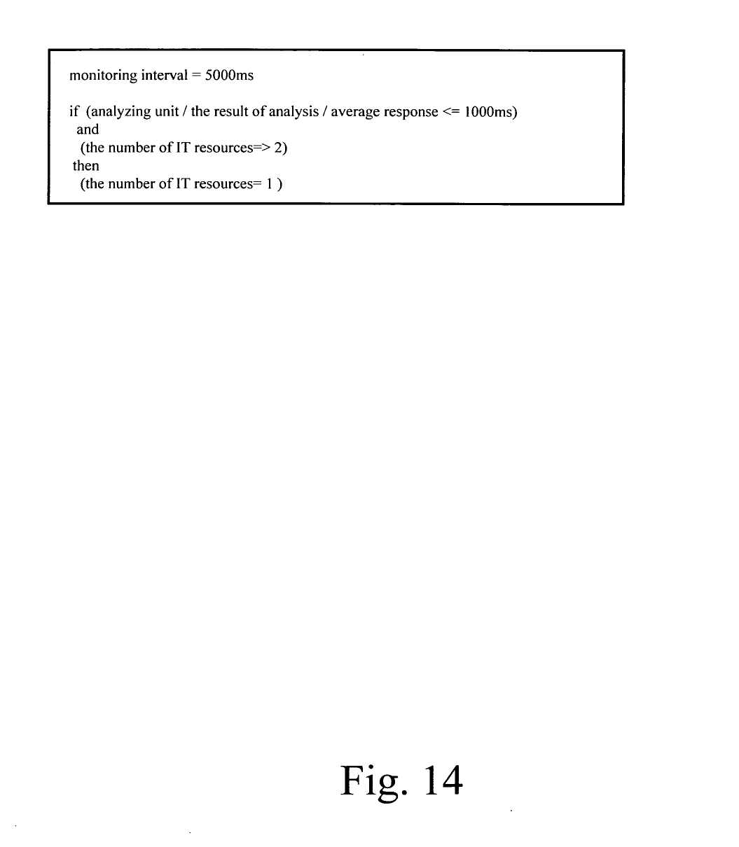

In the present embodiment, since the extracted basic policy information does not include a portion defining a service policy item, the change processing is not performed. FIG. 14 shows the control policy information stored in the policy storage unit 106 when processing in step S5001 is completed in the present embodiment.

Now, the control policy information will be described in more detail.

The control policy information is basically defined in the format of “if . . . then . . . ”. That is, when the conditions between “if” and “then” match each other, the processing subsequent to “then” is performed.

Multiple conditions can also be set using “and”/“or” between “if” and “then” as operators.

The statement subsequent to “if” in the control policy information shown in FIG. 14 indicates a control policy “If the result of analysis performed by the analyzing unit 113 shows that the average response time is 1000 ms or less and the number of IT resources during operation is 2 or more, the number of operation IT resources is set to 1”.

Next, in step S5002, the policy compiler 105 checks whether or not a value is specified for the item “average response time” in the service policy information stored in the policy storage unit 106. When a value is specified, the policy compiler 105 refers to the operation database 107 to extract response times for “no data” from previous cases and determines the average time of the extracted response times in step S5003. In step S5004, the policy compiler 105 updates the value of “average response time” indicated by the currently-stored control policy information. When no value is specified for the “average response time” in the service policy information stored in the policy storage unit 106, the policy compiler 105 does not perform processing described in steps S5003 and S5004.

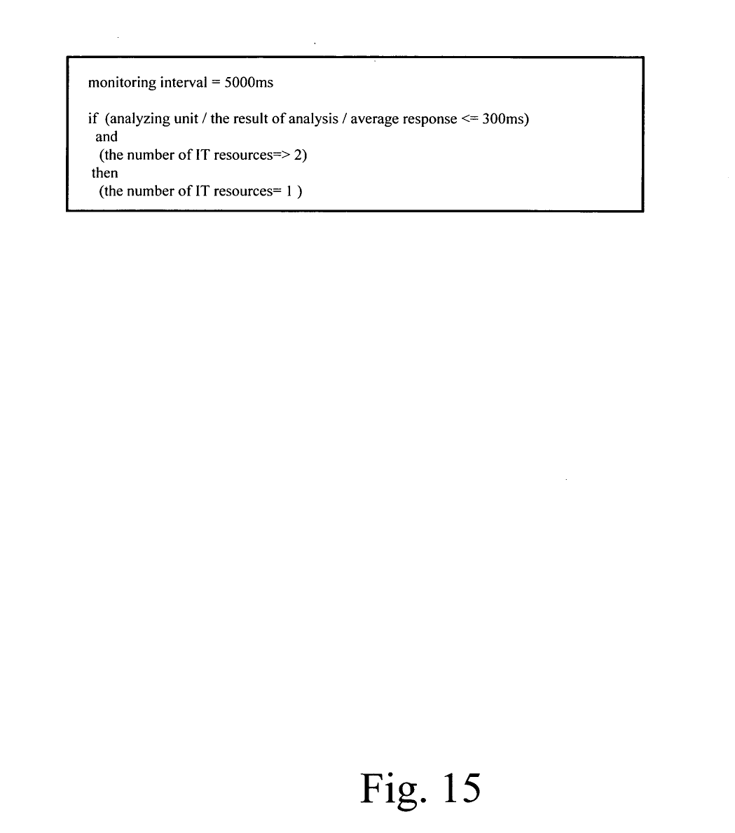

In the case of the present embodiment, as shown in FIG. 6, since “1300 ms” is specified for the item “average response time” in the service policy information stored in the policy storage unit 106, the processing in steps S5003 and S5004 is executed. In the present embodiment, in the processing in step S5003, it is assumed that the average value for the “response time” is “300 ms”. Thus, when the processing in step S5004 is completed, the value of the average response time in the control policy information stored in the policy storage unit 106 is updated from “1000 ms” to “300 ms”, as shown in FIG. 15.

When the processing in step S5004 is completed, in step S5005, the policy compiler 105 checks whether or not a value is specified for the “peak response time” in the service policy information stored in the policy storage unit 106. When a value is specified, in step S5006, the policy compiler 105 refers to the operation database 107 to extract the maximum response time of response times for “no data” from the previous cases. In step S5007, the policy compiler 105 then adds the value of the “peak response time”, indicated by the currently-stored control policy information, to the conditions. When no value is specified for the item “peak response time” in the service policy information stored in the policy storage unit 106 in the processing in step S5005, the policy compiler 105 does not perform the processing described in steps S5006 and S5007.

In the case of the present embodiment, as shown in FIG. 6, since “not specified” is defined for the item “peak response time” in the service policy information stored in the policy storage unit 106, the processing in steps S5005 and S5006 is not executed. In the present embodiment, when the processing is completed, the control policy information stored in the policy storage unit 106 is not updated.

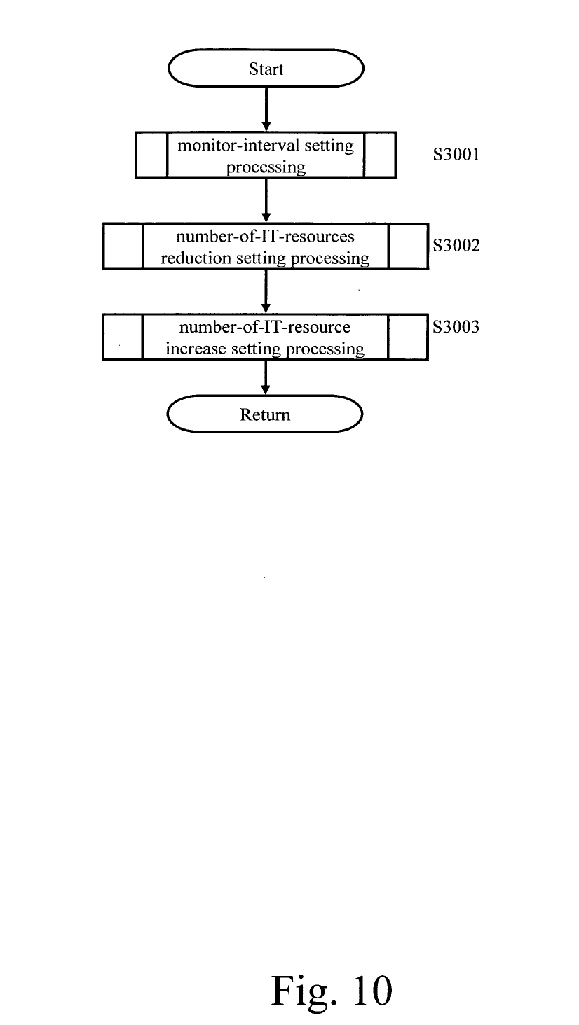

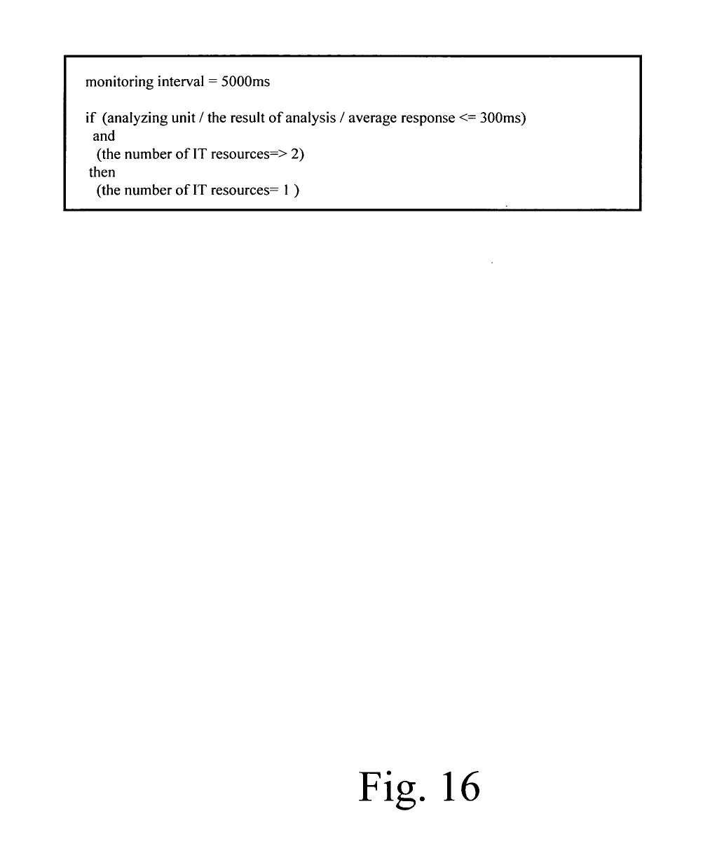

FIG. 16 shows control policy information stored in the policy storage unit 106 at the point when the processing in step S3002 shown in FIG. 10 is completed. In this example, since the processing in steps S5006 and S5007 were not performed, the control policy information shown in FIG. 16 is the same as the control policy information when the processing in step S5004 shown in FIG. 15 is completed.

The statement subsequent to “If” corresponds to the control policy information added in the IT resource reduction processing (S3002). The control policy information indicates that “When the result of the analysis performed by the analyzing unit shows that the average response time is 300 ms or less and the number of IT resources is 2 or more, the number of IT resources is set to 1”.

Although a determination is made in the above-described number-of-IT-resource reduction setting processing as to whether or not values are specified for the item “average response time” and the item “peak response time” in the service policy information, the values of the items are not reflected. The average response time and peak response policies indicate values for preventing the response from becoming slower than those values and do not indicate a response value for a case of “no data”. Thus, since the response value cannot be utilized, each response value is set based on a corresponding previous case stored in the operation database 107.

Since the issue is that where the “viewpoint” is placed to set a policy, the presence/absence of values for the items “average response time” and “peak response time” is referred to as a condition for the determination. In this case, since only the average response time is specified, only the average response time is set, as a condition, in high-order (business or service) policy information.

When the number-of-IT-resource reduction setting processing (step S3002) is completed, the number-of-IT-resource increase setting processing (in step S3003) is performed.

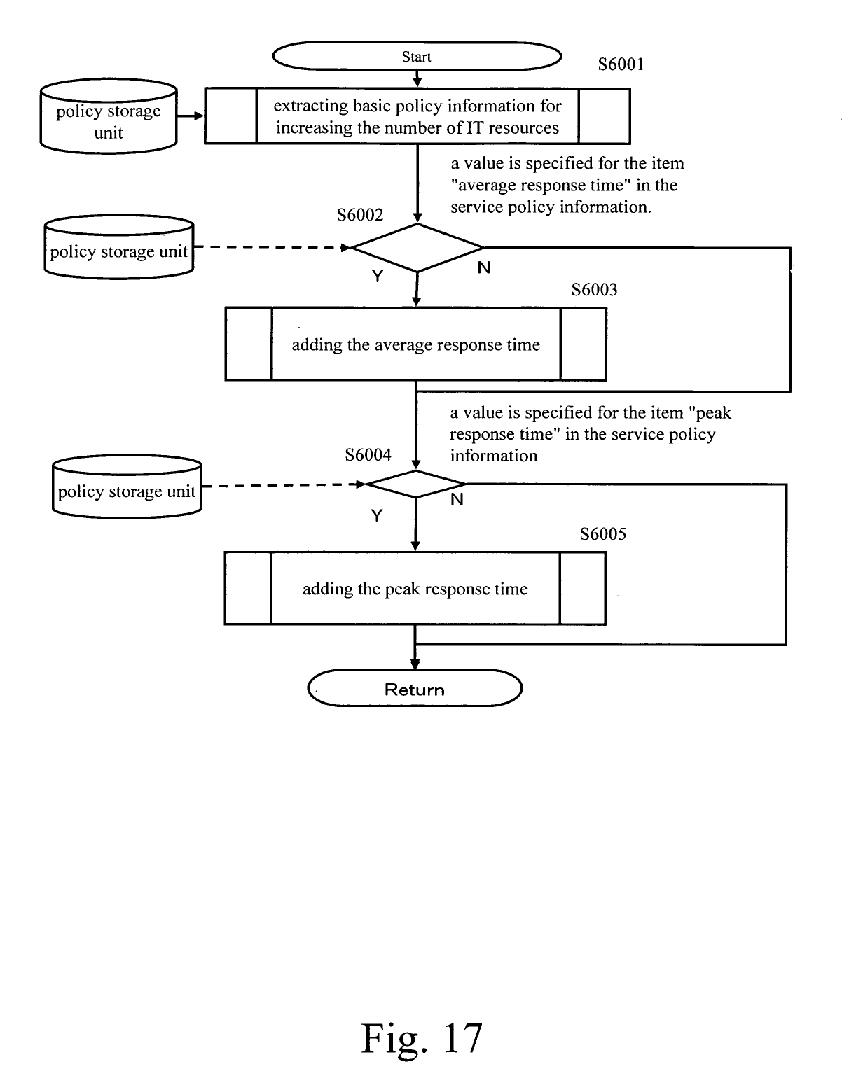

The number-of-IT-resource increase setting processing (in step S3003) will now be described with reference to FIG. 17.

In step S6001, the policy compiler 105 extracts, from the policy storage unit 106, basic policy information for increasing the number of IT resources and adds the extracted basic policy information to the control policy information stored in the policy storage unit 106. In this case, when a service policy information item is defined in the basic policy, the policy compiler 105 performs processing for changing the item portion to a value defined by the corresponding item of the service policy information stored in the policy storage unit 106.

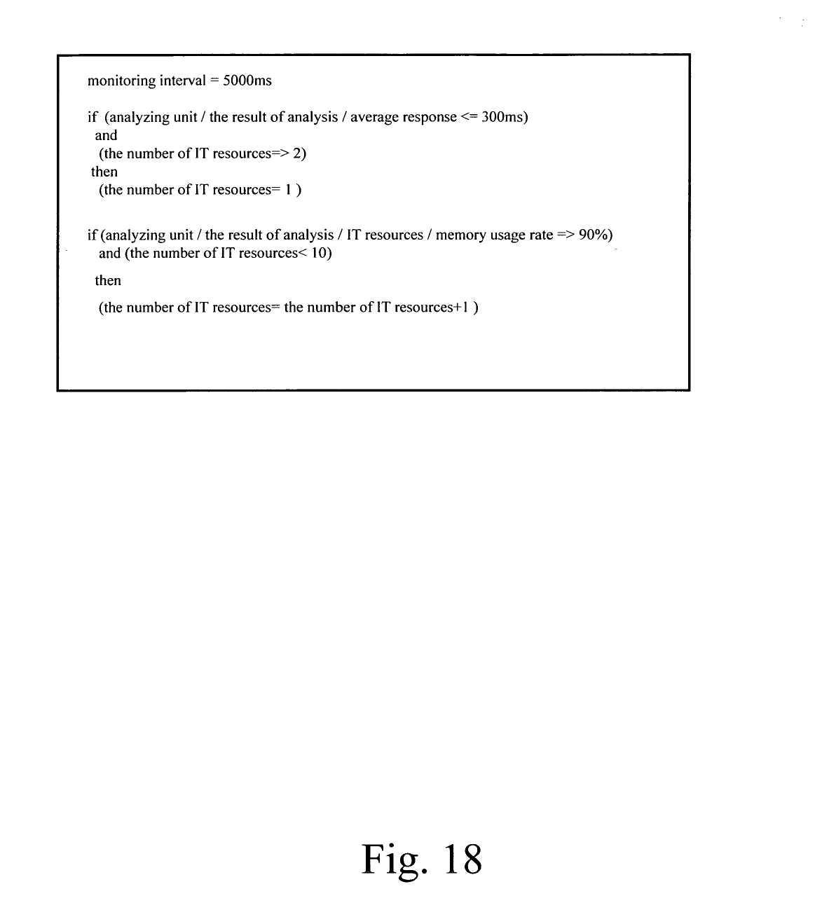

FIG. 18 shows information stored in the policy storage unit 106 at a point when the processing in step S6001 is completed. As shown, in the processing in step S6001, in the basic policy information, a statement subsequent to a second “if” is added and the portion indicating the “service policy/maximum number of secured IT resources” is updated to “10” defined in the service policy information.

Next, in step S6002, the policy compiler 105 checks whether or not a value is specified for the item “average response time” in the service policy information stored in the policy storage unit 106. When a value is specified, the policy compiler 105 adds response time specified for the “average response time” to the conditions of the control policy information. In this case, the initial condition is “analyzing unit/analysis result/IT resource/memory usage rate <=90%”. Since any of the conditions of the average response time and the memory usage rate is achieved, the condition for increasing IT resources is satisfied. Thus, in step S6003 the policy complier 105 adds the condition to the control policy information stored in the policy storage unit 106 and also inserts an operator “or” between the existing conditions.

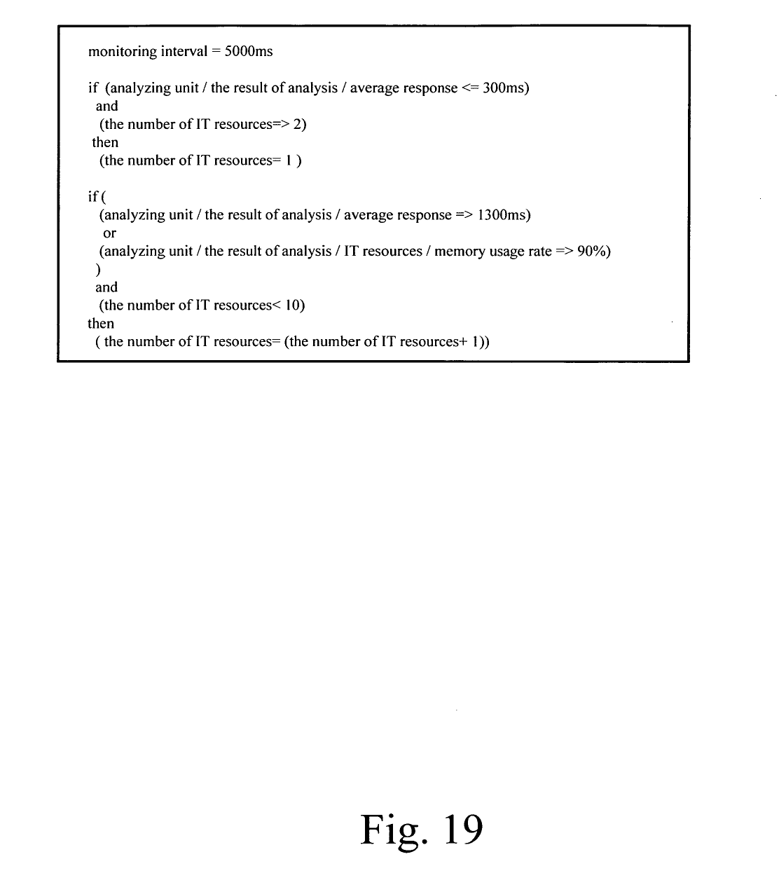

In the case of the present embodiment, since “1300 ms” is specified for the item “average response time” in the service policy information, a case in which the analysis result of the analyzing unit 113 indicates the specified “1300 ms” or more is added as a condition for adding IT resources. FIG. 19 shows the added control policy information. An underlined portion in FIG. 19 is the added control policy information.

When the processing in step S6003 is completed, the policy compiler 105 checks whether or not a value is specified for the item “peak response time” in the service policy information stored in the policy storage unit 106 in S6004. When a value is specified, in step S6005, the response time specified for the item “peak response time” is added to the conditions of the control policy information. The addition processing in this case is performed in the same manner as the processing in step S6003.

However, in the case of the present embodiment, since “not specified” is defined for the item “peak response time”, the processing is not performed.

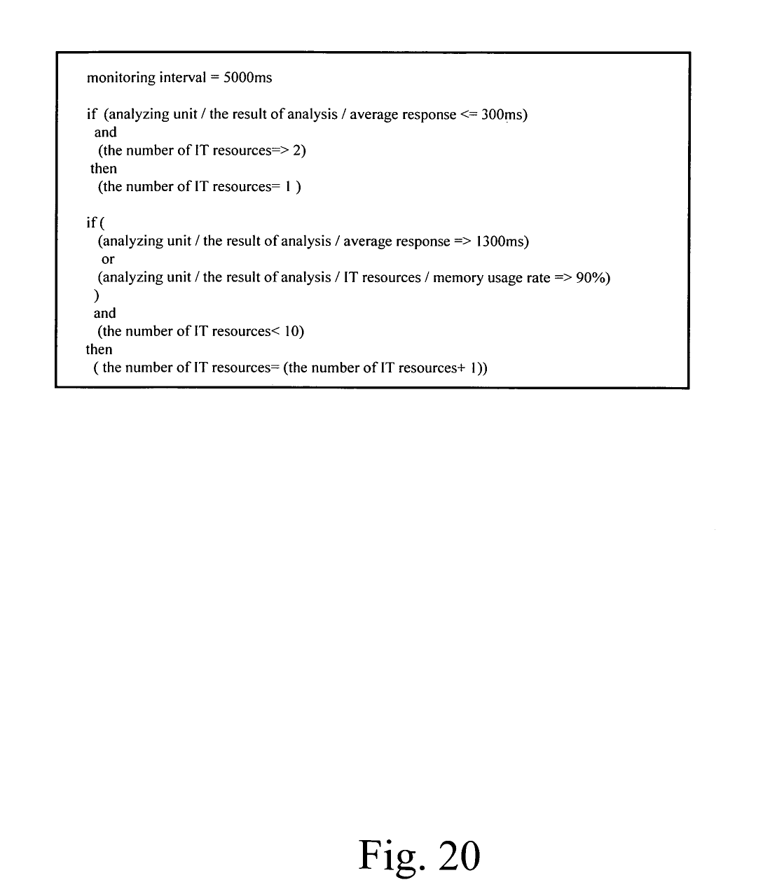

Thus, as shown in FIG. 20, the control policy information stored in the policy storage unit 106 when the number-IT-resource increase processing (S3003) is completed is the same as the information stored when the processing in S6003 is completed.

As described above, the statement after the second “if” shown in FIG. 20 indicates the control policy information added in the number-of-IT-resource increase processing (S3003). As shown, control policy information is added which indicates “the number of IT resource is increased by 1” when any of the conditions “the analysis result of the analyzing unit shows an average response time of 1300 ms or more” and “the analysis result of the analyzing unit shows that the ratio of memory used by IT resources is 90% or more” is satisfied and the condition “number of IT resources is 10 or less” is satisfied.

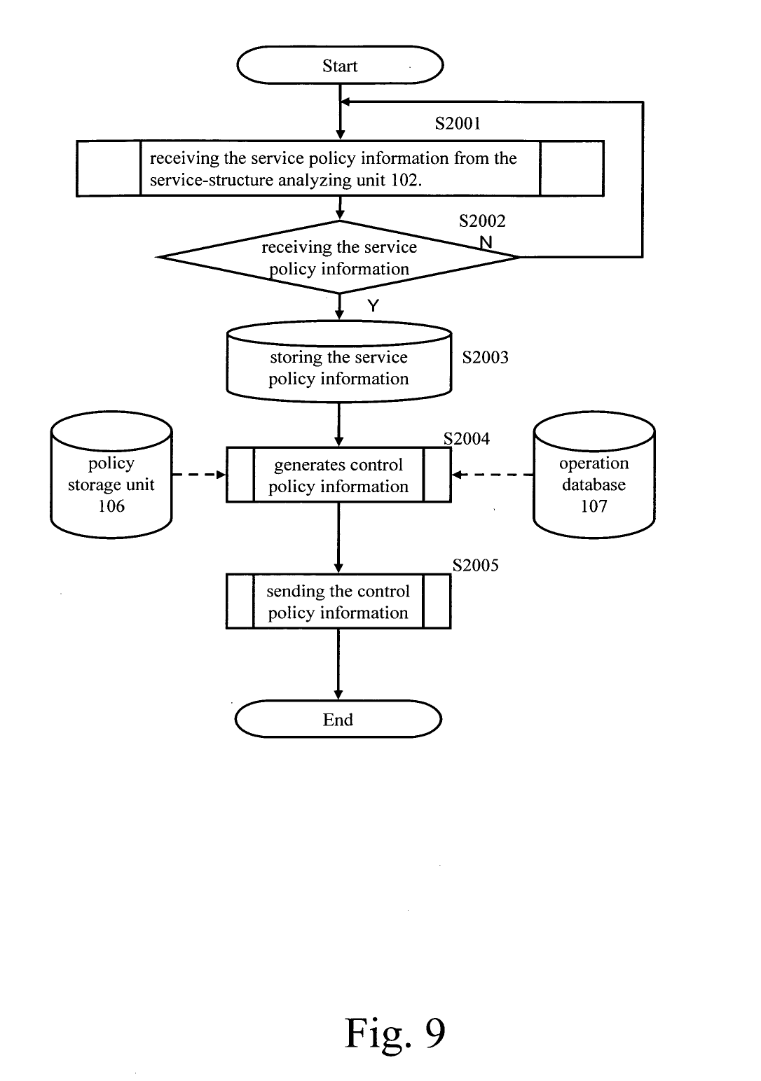

When the processing shown in FIG. 17 is thus completed, the control policy generation processing shown in FIG. 10, i.e., the processing in step S2004 shown in FIG. 9, is also completed. Thus, as shown in step S2005 shown in FIG. 9, the policy compiler 105 sends the control policy information stored in the policy storage unit 106, i.e., the control policy information shown in FIG. 20, to the flow controller 109.

Upon receiving the control policy information, the controller 116 of the flow controller 109 stores the control policy in the policy storage unit 111. Based on the stored control policy, the controller 116 controls the monitoring/measuring unit 112, the analyzing unit 113, the designing/verifying unit 114, and the operation unit 115. The processing of this control is similar to the processing disclosed in Patent Document 1 described above, and the detail thereof is not described herein.

As described above, according to the present embodiment, the user can convert business policy information indicating business requirements into control policy information for actually controlling IT resources, via service policy information indicating configurations.

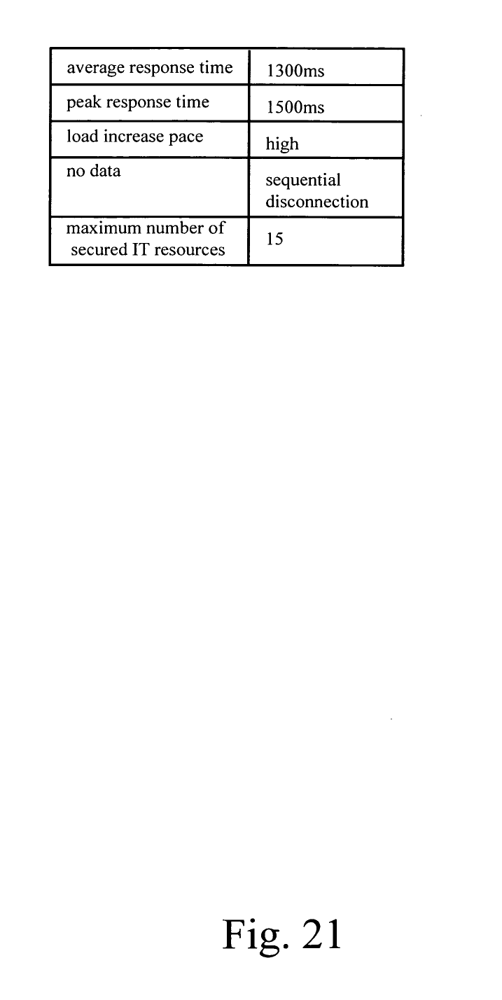

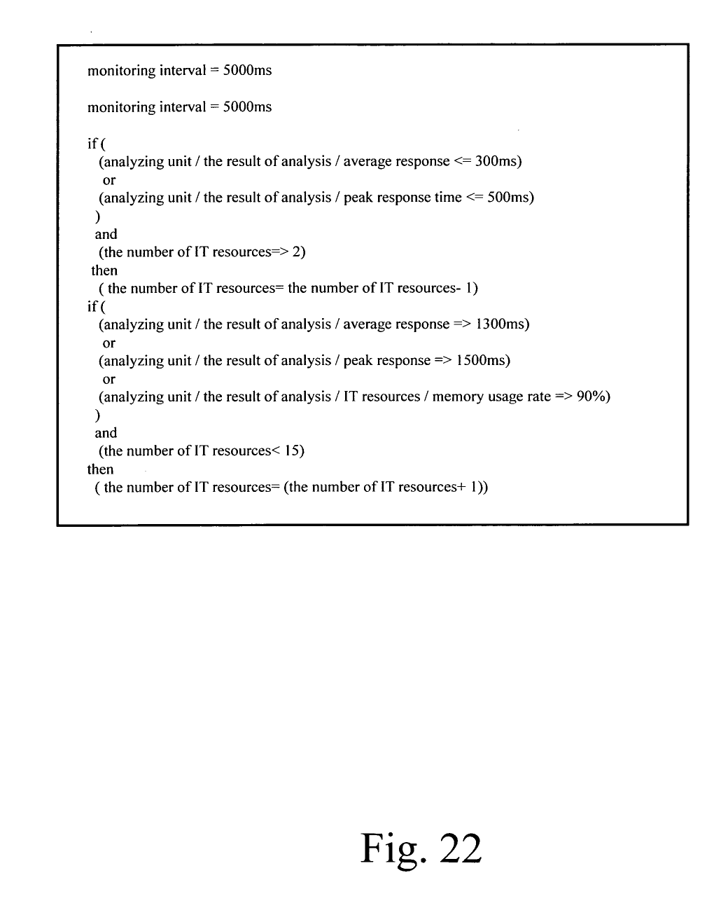

In the present embodiment, when “Emphasis on performance & Response guaranteed even in worst state” for the “business policy information” is input to the business policy input unit 101, as “business policy information”, via the business-policy input unit 101, the service policy information output from the service-structure analyzing unit 102 is shown in FIG. 21 and the control policy information output from the policy compiler 105 is shown in FIG. 22. Since the processing is the same as the processing described above, the description thereof is not given below.

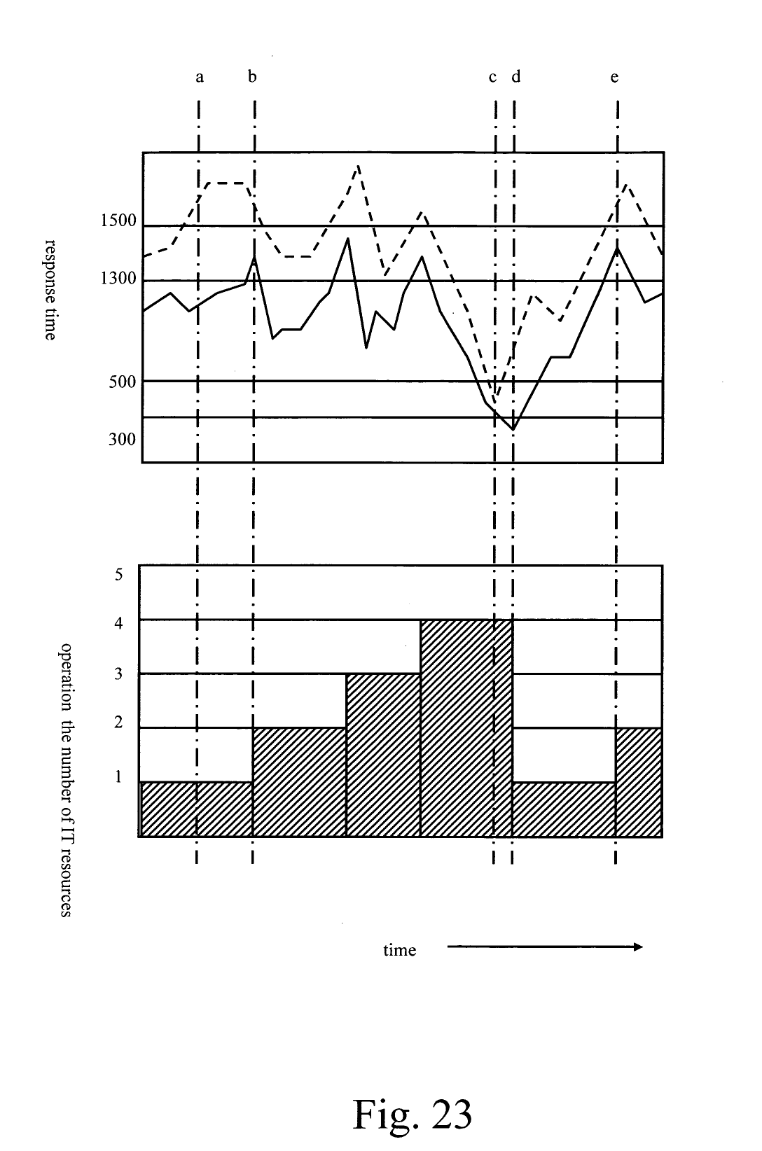

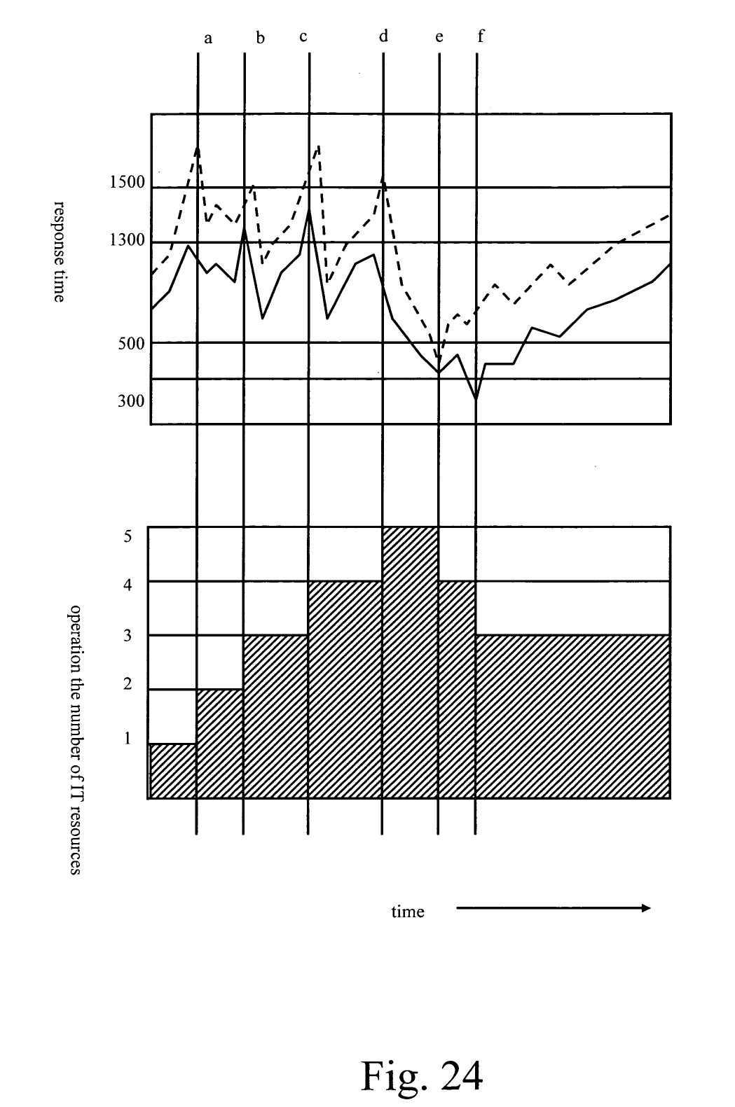

An increase and reduction in IT resources in response to a response in the state in which the control policy is generated as described above will now be described with reference to FIGS. 23 and 24.

FIG. 23 includes graphs illustrating an increase/reduction in the number of IT resources when the user inputs a business policy “Emphasis on cost efficiency & Average response maintained” to the business-policy input unit 101 in the embodiment described above.

The upper graph in FIG. 23 is a time-elapse graph indicating average response time and peak response time output from the analyzing unit 113 based on information received from the monitoring/measuring unit 112.

In this graph, the solid line indicates the average response time and the dotted line indicates the peak response time.

The lower graph shows an increase/decrease in the number of operation IT resources.

Control policy information for the case in which the user inputs “Emphasis on cost efficiency & Average response maintained” to the business-policy input unit 101 is the business policy information shown in FIG. 20, as described above, and in accordance with the control policy, the flow controller 109 controls each IT resource.

In the case of the business policy, the control policy considers only the average, and thus, even when the actual response time exceeds a peak response time of 1500 ms set by the business policy “Emphasis on performance & Response guaranteed even in worst state”, the number of IT resources is not increased (see point a), unless the actual peak response time does not exceed 1300 ms, which is the threshold of the average response time.

Conversely, when the threshold of the average response time exceeds 1300 ms, control for adding one IT resource is performed as indicated by point b.

Similarly, control for reducing the number of IT resources is not performed at point C, since no consideration is given for the peak response time at which it is determined that there is no data.

When the average response time falls below 300 m (see point d), which is reference response time at which it is determined that there is no data, the system in which four IT resources have been operated before that point is put, by a single operation, into a state in which one IT resource is operated.

With this arrangement, control for reducing the number of operation IT resources, i.e., control for putting emphasis on cost efficiency, is performed based on the response time.

FIG. 24 includes graphs illustrating an increase/reduction in the number of IT resources when the user inputs the business policy “Emphasis on performance & Response guaranteed in worst state” to the business-policy input unit 101 in the embodiment described above.

As described above, the control policy information corresponds to the control policy information shown in FIG. 22.

In this control policy information, the peak response time is also specified to 1500 ms and, when either the value “1300 ms” specified for the average response time or the peak response time is exceeded, the processing for increasing the number of IT resources is performed (see points a to d).

Also, when either the peak response time or the average response time falls below the corresponding specified value (500 ms or 300 ms), it is determined that the number of IT resources is reduced. As described above, when the business policy information “Emphasis on cost efficiency & Average response maintained” is input, the number of IT resources is reduced to 1 by a single operation. However, when the business policy information is input, control for sequentially reducing the number of IT resources one by one is performed as indicated by points e and f.

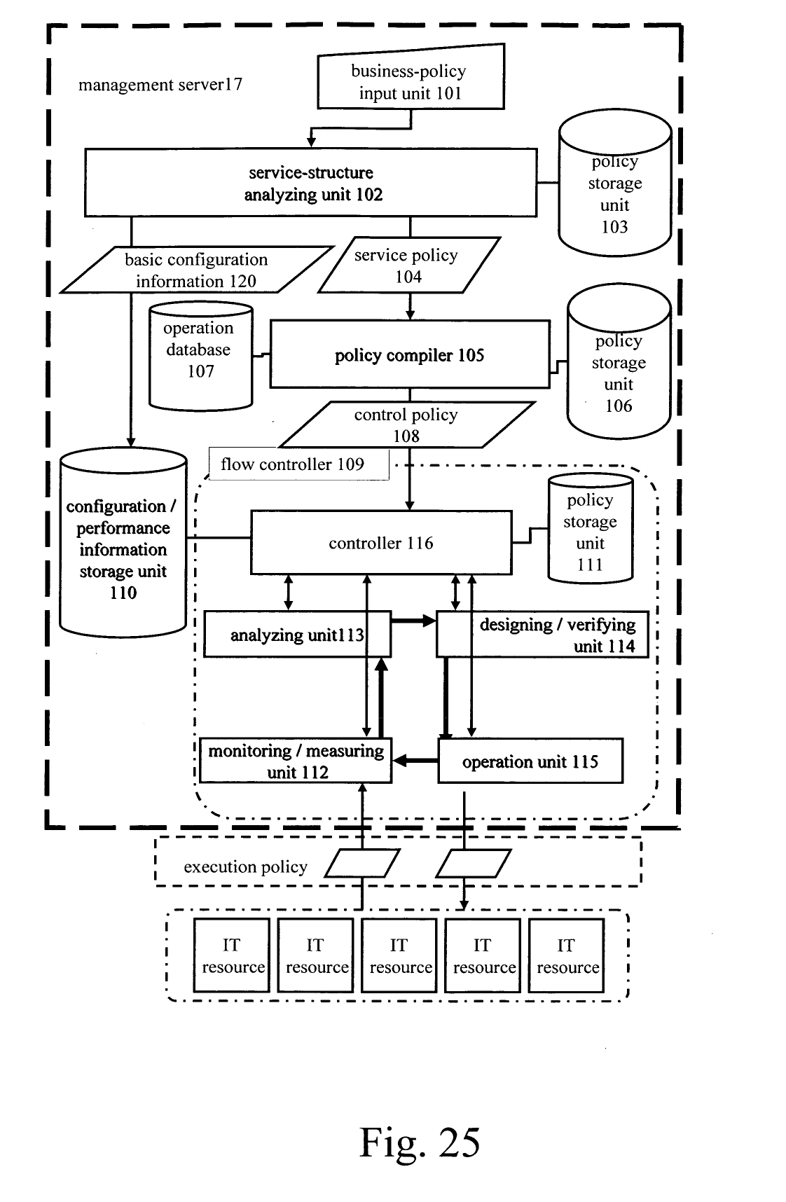

In the embodiment described above, the service-structure analyzing unit 102 refers to the business-policy—service-policy relationship table, stored in the policy storage unit 103, and outputs only the service policy information. However, as shown in FIG. 25, basic configuration information in each business policy may be associated with the relationship table and be stored in the policy storage unit 103, so that the service-structure analyzing unit 102 outputs basic configuration information 120 in response to an input from the business-policy input unit 101. The basic configuration information 120 is then stored by the configuration/performance information storage unit 110 and used by the flow controller 109.

In addition, although the service policy information is output based on the business-policy—service-policy relationship table stored in the policy storage unit 103 in the embodiment described above, the basic configuration information 120 may be generated after performing simulation for business analysis.

In addition, in the embodiment described above, the policy compiler 105 refers to case information stored in the operation database 107 to perform processing. However, a verifying unit (simulator) 130 may be provided, so that, instead of the case information, information verified by the simulator is used to generate the control policy information. In addition, the arrangement may be such that case information in the operation database 107 is basically used, and when the policy compiler 105 uses information that is not included in the case information, the verifying unit 130 performs verification.

Additionally, although the operation of only one policy has been described in the embodiment described above, two or more policies can be used to control the entire system. For example, a range controlled by one policy may be restricted to a section (subsystem) so as to control the entire system by using a combination of subsystem policies. In this manner, restricting a range controlled by one policy in the system facilitate that each policy is defined and read.

For example, for a web service, a web server, an application, a database server, and so on are typically connected in a hierarchical manner to perform processing and a control policy for monitoring and analyzing loads on the web server and a control policy for monitoring and analyzing a failure in the application server are substantially separated from each other. When an attempt is made to define the processing by using one policy, the policy becomes complicated. Thus, it is desired that such control policies for the independent servers be implemented with different control policies.

In order to meet the requirement, a plurality of independent subsystems in a single system must be operated, thus requiring control for determining which IT resource performs based on which subsystem.

The simplest scheme may be a scheme in which IT resources that can be used by each subsystem in a system are predetermined and are used only a corresponding single subsystem in a completely exclusive manner.

However, cases in which IT resources cannot be efficiently used can occur, including a case in which even though one subsystem has sufficient IT resources, another subsystem may not have any available IT resource.

Thus, for example, standby IT resources may be shared by multiple subsystems so that a shared standby IT resource is allotted to a subsystem that requires the addition of an IT resource, thereby achieving efficient use of the IT resources.

However, when the system is configured to permit a shared standby IT resource to be independently allotted to each subsystem, multiple subsystems may perform processing for acquiring the same IT resource.

Thus, in order to perform control for such a situation, coordination between the subsystems is required.

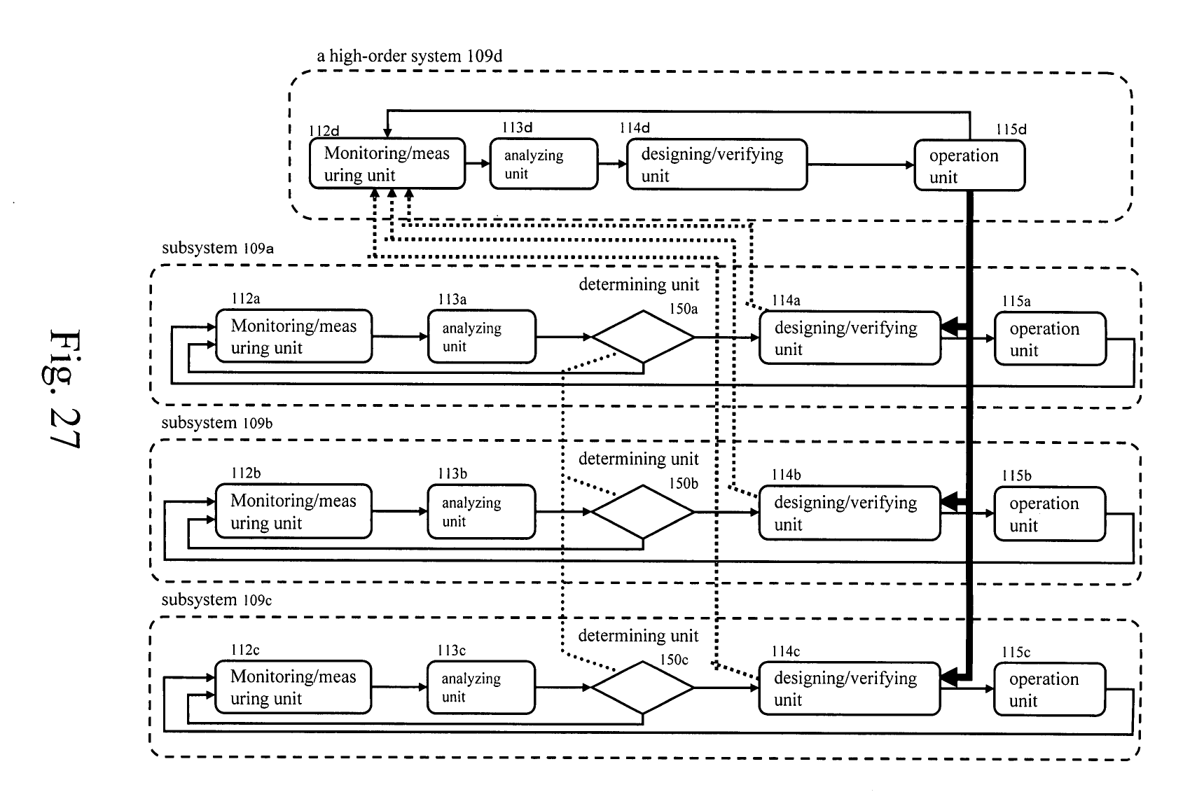

FIG. 27 shows an example of a system implemented in view of the situation described above.

In this system, subsystems 109a to 109c (corresponding to the flow controller 109 shown in FIG. 3) performs flow control in accordance with the control policy. Monitoring/measuring units 112a to 112c each have the same configuration as the monitoring/measuring unit 112 shown in FIG. 3 and analyzing units 113a to 113c each have the same configuration as the analyzing unit 113 shown in FIG. 3.

Determining units 150a to 150c determine whether or not the system needs to be redesigned based on the results of analysis of the corresponding analyzing units 113a to 113c. When the redesigning is not needed, the process proceeds to the processing of the monitoring/measuring units 112a to 112c, and when the redesigning is needed, the determining units 150a to 150c performs “synchronization processing” for synchronizing the designing and verifying timing with the other subsystems.

Designing/verifying units 114a to 114c in the respective subsystems are different from the designing/verifying unit 114 in FIG. 3 in that they perform designing/verifying processing at the synchronization time of the synchronization processing performed by the determining units 150a to 150c.

When each of the designing/verifying units 114a to 114c determines that a coordination-related problem, such as acquiring the same reserve IT resource, occurs, a high-order system 109d issues a notification to each subsystem and performs adjustment for acquiring IT resources.

In the high-order system 109d, a monitoring/measuring unit 112d monitors design and problem states in each subsystem, an analyzing unit 113d analyzes the result of the monitoring, and a designing/verifying unit 114d performs designing/verifying processing. Thereafter, an operation unit 115d issues a notification indicating the result of the designing/verifying processing to all of the designing/verifying units 115a to 115c of the subsystems or to the designing/verifying unit in a subsystem that requires an operation.

The designing/verifying units 114a to 114c that have received the notification performs redesigning based on the information indicated by the notification and performs processing for acquiring/releasing an IT resource based on the result of the redesigning.

In this system, each subsystem stores multiple patterns and selects a pattern therefrom according to the control policy to perform the synchronization.

This is intended, in the design, to prevent conflicts for acquiring a shared resource and to allow subsystems having higher priority to sequentially acquire resources.

A specific example of the synchronization processing and conflict prevention processing will be described.

A case in which IT-resource addition processing is required as a result of the analysis performed by the analyzing unit 113a in the subsystem 109a will be described in this example.

As described above, the determining units 150a to 150c use the corresponding analyzing units 113a to 113c in the subsystems 109a to 109c to monitor an output indicating the necessity of redesigning.

Here, when the analyzing unit 113a sends an output indicating the necessity of IT-resource addition processing, the determining unit 150a receives the output and issues, to the determining units 150b and 150c in the other systems, a notification indicating wait time (e.g., 5 minutes) and a redesign notification indicating the necessity of redesigning. When the wait time elapses, the determining unit 150a issues a notification requesting the redesigning to the designing/verifying unit 114a.

In response to the redesign and wait-time information, the determining units 150b and 150c in the subsystems 109b and 109c check whether or not an redesign-requesting output is received from the analyzing units 113b and 113c in the subsystems 109b and 109c until the received wait time elapses.

When a redesign-requesting output is received from the analyzing unit 113b in the subsystem 109b before the wait time elapses, the analyzing unit 113b sends an output for aiding the redesign to the designing/verifying unit when the wait time elapses.

In this state, the designing/verifying units 114a and 114b perform redesigning at the same time.

With respect to the processing performed by the analyzing units 113a to 113c after the wait time elapses, the determining units 150a to 150c send outputs for redesigning to the designing/verifying units 114a to 114c, when the designing/verifying processing of the designing/verifying units 114a and 114b is completed.

The redesign information from the designing/verifying units 114a and 114b in the subsystems is sent to the monitoring/measuring unit 112d in the high-order system 109d.

As described above, since the designing/verifying units 114a and 114b performs redesigning processing at the same time, the redesign information from the designing/verifying unit 114a and the redesign information from the designing/verifying unit 114b are sent to the designing/verifying unit 114d at substantially the same time.

The monitoring/redesigning unit 112d receives the information and transfers the resulting information to the analyzing unit 113d. Then, the analyzing unit 113d performs analysis as to whether or not subsystems are conflicting with each other to acquire an IT resource and whether or not the entire system is designed to have sufficient IT resources, and outputs the result of the analysis to the designing/verifying unit 114d.

In response to the result of the analysis, the designing/verifying unit 114d determines a subsystem that is to acquire an IT resource by priority, performs designing and verifying processing for releasing an IT resource of another subsystem during operation and adding the released IT resource to a subsystem that requires it, and outputs the resulting information to the operation unit 115d.

In response to and based on the information, the operation unit 115d issues a notification indicating subsystem-redesign information, redesigned and verified by the designing/verifying system, to the designing/verifying units 114a to 114c in the corresponding subsystems.

In response to the notification, the designing/verifying units 114a to 114c perform designing/verifying processing based on the redesign information sent from the high-order system 109d and output the resulting information to the operation units 115a to 115c in the subsystems 109a to 109c. The operation units 115a to 115c perform IT-resource reconfiguration processing in accordance with the output information.

In the example described above, when a predetermined amount of time elapses after the redesign request is received from the determining unit in one subsystem, the synchronization processing, i.e., the designing/verifying processing, is performed. As an alternative synchronization method, when an abnormality occurs in one subsystem, all the other subsystems may be caused to perform measurement/analysis regardless of a monitoring/measuring cycle to determine a necessary resource and processing.

This arrangement makes it possible to perform control for actively checking a case (i.e., without checking a case in a stand-by manner) with respect another subsystem. Examples include a case of “Monitoring, set to be performed every 5 minutes, was performed just 1 minute ago, but a threshold can be currently exceeded” and a case of “If there is an opportunity of redesigning even when a predetermined threshold is not exceeded, the number of resources is somewhat increased to adjust the number”.

As described above, subsystems that require redesigning are given priorities so as to sequentially acquire resources.

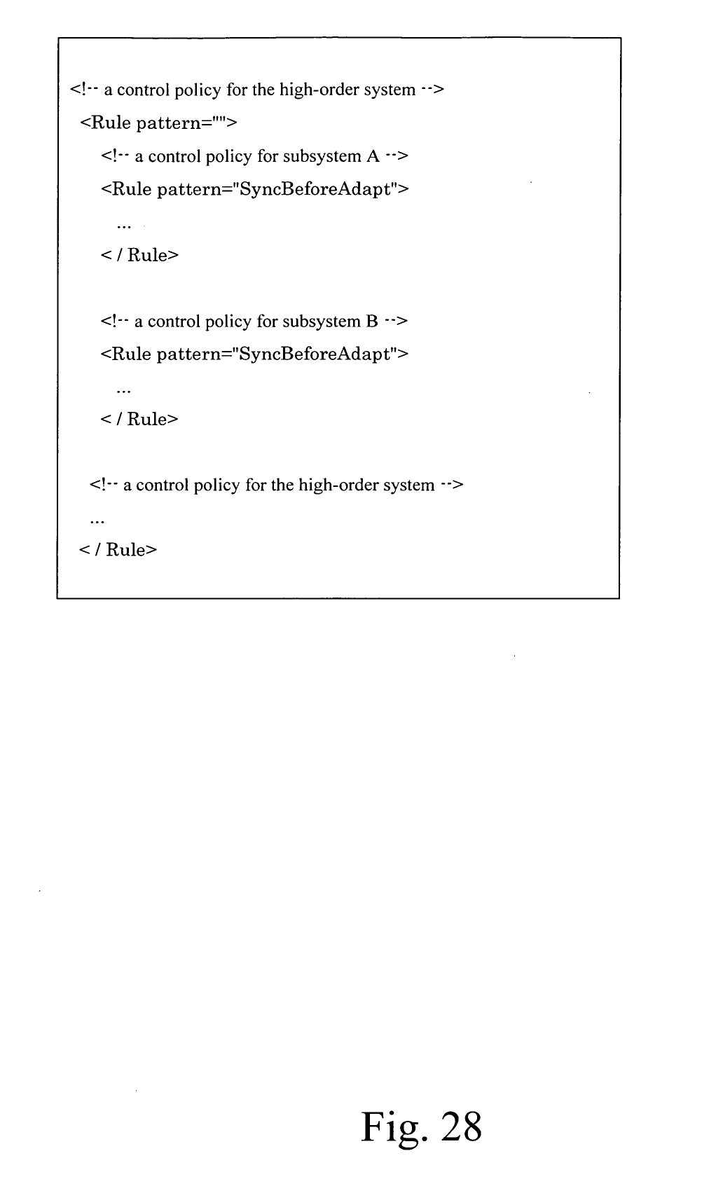

In this example, as shown in FIG. 28, a policy describing what synchronization pattern is to be taken between subsystems is defined and the high-order system executes synchronization according to the synchronization pattern of the subsystem. This policy is an example of a definition of a control policy for the high-order system 109d and is written in an XML format. Statements are nested in FIG. 28, but may be separated. In the system, the monitoring/measuring unit 112d in the high-order system 109d monitors outputs sent from the designing/verifying units 114a to 114c to detects problems. However, in a normal state, the designing/verifying units 114a to 114c may perform communication with each other to determine whether or not there is any problem. In such a case, being triggered by the occurrence of a problem, the designing/verifying units 114a to 114c issues a notification to the monitoring/measuring unit 112d in the high-order system 109d, and being triggered by the notification, the monitoring-verifying unit 112d issues a notification to the analyzing unit 113d.

As described above, for example, the high-order system 109d performs control for synchronizing the subsystems to thereby make it possible to provide solutions, such as causing the high-order system 109d to release a server to another (peer) subsystem or acquiring a server from a server pool prepared at a high-order level. This makes it possible to automatically configure a system that allows more efficient use of IT resources.

When the above-noted synchronization pattern is selected from prescribed patterns, the implementation of the flow controller is facilitated and the operation management flow becomes more typical and thus can be expressed in a certain pattern. In this case, provision of synchronization-pattern editing means makes it possible to easily define an appropriate synchronization pattern.

In the above-described example, the defining/verifying units 114a to 114c in the flow controllers 109a to 109c essentially perform design processing independently and in parallel. However, the design processing may be performed in the order of the designing/verifying unit 114a, the designing/verifying unit 114b, and the designing/verifying unit 114c. In such a case, the designing/verifying unit 114a first performs control for design processing by freely using shared resources, the designing/verifying unit 114b performs control for design processing by using shared resources that were not used by the designing/verifying unit 114a, and the designing/verifying unit 114c performs control for design processing by using shared resources that were not used by the designing/verifying unit 114b. Further, when a problem arises in any of the designing/verifying units 114a to 114c, a notification may be issued to the high-order flow controller 109d.

In the embodiment described above, when the service policy is generated from the business policy and when the service policy is converted into the control policy, the results obtained by the service-structure analyzing unit and the policy compiler are directly reflected. However, modifying means may be provided for presenting the conversion result to the administrator to allow him or her to make a modification. This arrangement allows the administrator to check whether or not conversion intended by him/her is performed and also allows him/her to make a modification if the intended conversion is not performed.

In addition, in the service policy, the peak/average response time that serves as a trigger for increasing the number of servers is copied from the service policy. For example, when a statement “It is desired to reduce the average to 2000 ms or less” is written in the service policy, it is too late to take measures after the average exceeds 2000 ms and thus the control policy may be defined by considering such a situation.

For example, a value requested by the service policy may be multiplied by a predetermined coefficient (e.g., 0.7) that has been empirically obtained, and conversion is performed to match the value.

Alternatively, for example, step-by-step simulations are performed in advance for, for example, “a case in which measures are taken after 1000 ms is exceeded” and “a case in which measures are taken after 1100 ms is exceeded” and conversion is performed in such a manner that a service policy indicating a reliable value that can ensure 2000 ms or less is selected.

Performing any of the processing described above makes it possible to perform more reliable policy operation.

The arrangement may also be such that the monitoring/measuring unit 112, the analyzing unit 113, the designing/verifying unit 114, and the operation unit 115, which are the elements of the flow controller, are configured functional modules and the controller 116 uses a common interface provided for each functional module to call up each functional module. Further, provision of an adapter for converting the format of recalling a common interface into a format that can be understood by each functional module can facilitate that each functional module is used according to an application.

What is claimed is:

1. An autonomous control program on a computer readable medium comprising:
a service-structure analyzing unit for generating service policy information indicating a configuration requirement, in response to business policy information indicating a business requirement;
a policy compiler for generating a control policy from the service policy information generated by the service-structure analyzing unit, based on a previous case or a result of verification using simulation, the control policy serving an actual IT-resource control requirement; and
a flow controller for controlling IT resources in accordance with the control policy generated by the policy compiler.

2. The medium according to claim 1, wherein the service policy information generated by the service-structure analyzing unit comprises an item for a step of reducing the number of IT resources.

3. The medium according to claim 2, wherein the item for reducing the number of IT resources is capable of specifying a control instruction for changing the number of operation IT resources to one.

4. The medium according to claim 2, wherein the item for reducing the number of IT resources is capable of specifying a control instruction for reducing the number of operation IT resources one by one.

5. The medium according to claim 1, wherein the service policy information generated by the service-structure analyzing unit comprises items for specifying average response time and peak response time; and the policy compiler generates control policy information, while referring to whether or not values are specified for the average response time and the peak response time in the service policy information generated by the service-structure analyzing unit.

6. The medium according to claims 1, wherein the flow controller comprises: functional modules having respective functions; a controller for calling up each functional module by using a common interface defined for each functional module; and an adapter for converting a format of the call-up into a format that can be understood by a functional module to be called up and for supplying the resulting information to the functional module to be called up.

7. The medium according to claims 1, wherein the flow controller is capable of performing a plurality of flow controls based on the control policy and comprises a high-order flow controller for performing IT-resource adjustment between the flow controls.

8. An autonomous control method comprising:
a service-structure analyzing step of generating service policy information indicating a configuration requirement, in response to business policy information indicating a business requirement;
a policy generating step of generating a control policy from the service policy information generated in the service-structure analyzing step, based on a previous case or a result of verification using simulation, the control policy serving as an actual IT-resource control requirement; and
a flow controlling step of controlling IT resources in accordance with the control policy generated in the policy generating step.

9. The method according to claim 8, wherein the service policy information generated by the service-structure analyzing unit comprises an item for a step of reducing the number of IT resources.

10. The method according to claim 8, wherein the item for reducing the number of IT resources is capable of specifying a control instruction for changing the number of operation IT resources to one.

11. The method according to claim 9, wherein the item for reducing the number of IT resources is capable of specifying a control instruction for reducing the number of operation IT resources one by one.

12. The method according to claim 8, wherein the service policy information generated by the service-structure analyzing unit comprises items for specifying average response time and peak response time; and the policy compiler generates control policy information, while referring to whether or not values are specified for the average response time and the peak response time in the service policy information generated by the service-structure analyzing unit.

13. The method according to claim 8, wherein the flow controller comprises: functional modules having respective functions; a controller for calling up each functional module by using a common interface defined for each functional module; and an adapter for converting a format of the call-up into a format that can be understood by a functional module to be called up and for supplying the resulting information to the functional module to be called up.

14. The method according to claim 8, wherein the flow controller is capable of performing a plurality of flow controls based on the control policy and comprises a high-order flow controller for performing IT-resource adjustment between the flow controls.

15. An autonomous control apparatus comprising:
a service-structure analyzing unit for generating service policy information indicating a configuration requirement, in response to business policy information indicating a business requirement;
a policy compiler for generating a control policy from the service policy information generated by the service-structure analyzing unit, based on a previous case or a result of verification using simulation, the control policy serving an actual IT-resource control requirement; and
a flow controller for controlling IT resources in accordance with the control policy generated by the policy compiler.

16. The apparatus according to claim 15, wherein the service policy information generated by the service-structure analyzing unit comprises an item for a step of reducing the number of IT resources.

17. The apparatus according to claim 15, wherein the item for reducing the number of IT resources is capable of specifying a control instruction for changing the number of operation IT resources to one.

18. The apparatus according to claim 15, wherein the item for reducing the number of IT resources is capable of specifying a control instruction for reducing the number of operation IT resources one by one.

19. The apparatus according to claim 15, wherein the service policy information generated by the service-structure analyzing unit comprises items for specifying average response time and peak response time; and the policy compiler generates control policy information, while referring to whether or not values are specified for the average response time and the peak response time in the service policy information generated by the service-structure analyzing unit.

20. The apparatus according to claims 15, wherein the flow controller comprises: functional modules having respective functions; a controller for calling up each functional module by using a common interface defined for each functional module; and an adapter for converting a format of the call-up into a format that can be understood by a functional module to be called up and for supplying the resulting information to the functional module to be called up.
